(19) United States
(12) Patent Application Publication
(10) Pub. No.: US 2023/0274128 A1
(43) Pub. Date: Aug. 31, 2023

(54) METHOD AND APPARATUS FOR ACCELERATED OPTIMIZATION

(71) Applicant: THE UNITED STATES OF AMERICA, AS REPRESENTED BY THE SECRETARY OF THE NAVY, Arlington, VA (US)

(72) Inventors: Isaac Michael Ross, Monterey, CA (US); Mark Karpenko, Salinas, MD (US)

(21) Appl. No.: 18/105,494

(22) Filed: Feb. 3, 2023

Related U.S. Application Data
(60) Provisional application No. 63/306,356, filed on Feb. 3, 2022.

(51) Int. Cl. G06N 3/0464; G06N 3/08

(52) U.S. Cl. CPC G06N 3/0464; G06N 3/08

(57) ABSTRACT

A method, apparatus and system including the execution of an accelerated optimization method. According to an exemplary embodiment, the accelerated optimization method includes: first-order optimality conditions for a generic nonlinear optimization problem are generated as part of the terminal transversality conditions of an optimal control problem. It is shown that the Lagrangian of the optimization problem is connected to the Hamiltonian of the optimal control problem via a zero-Hamiltonian, infinite-order, singular arc. The necessary conditions for the singular optimal control problem are used to produce an auxiliary controllable dynamical system whose trajectories generate algorithm primitives for the optimization problem. A three-step iterative map for a generic algorithm is designed by a semi-discretization step. Neither the feedback control law nor the differential equation governing the algorithm need be derived explicitly. A search direction is produced by a proximal-aiming-type method that dissipates a control Lyapunov function. New step size procedures based on minimizing control Lyapunov functions along a search vector complete the design of the accelerated optimization algorithms.

### CROSS REFERENCE TO RELATED PATENT(S) AND APPLICATION(S)

This application claims the benefit of U.S. Provisional Application No. 63/306,356, filed Feb. 3, 2022, and entitled Method and Apparatus for Accelerated Optimization, which is hereby incorporated in its entirety by reference.

### BACKGROUND

Many industries and their applications need to solve optimization problems to find the best solution, configuration, schedule, operating point, classification and/or regression from a set of all feasible solutions. In many instances, feasible solutions are constrained by linear and/or nonlinear equations, meaning that only certain solutions are admissible.

A generic, constrained, nonlinear optimization problem can be expressed mathematically as:

$$( N ) \{ \begin{matrix}{Minimize}_{{x}_{f} ∈ C ⊆ {ℝ}^{{N}_{x}}} & E ( {x}_{f} )\end{matrix}$$

where E is an objective function, and C is a linear and/or nonlinear constraint set. A specific example from the field of machine learning is found in deep networks:

$$\begin{matrix}{Minimize}_{\partial } & \frac{1}{n} {\sum }_{k = 1}^{n} loss ( {z}_{k}^{( l )} , {y}_{k} ) \\ Subject to & {z}_{k}^{( ℓ )} = {f}_{ℓ} ( {z}_{k}^{( ℓ - 1 )} , {ϑ}_{ℓ} ) \\ & {z}_{k}^{( ℓ - 1 )} = {f}_{ℓ - 1} ( {z}_{k}^{( ℓ - 2 )} , {ϑ}_{ℓ - 1} ) \\ & ⋮ \\ & {z}_{k}^{( 1 )} = {f}_{1} ( {x}_{k} , {ϑ}_{1} ) .\end{matrix}$$

In the above, the loss function is typically the squared error between the predicted output zₖ^{(l)} and the target output yₖ. Other loss functions are also possible. The constraints represent the forward flow equations through the network and are the parameters to be determined by optimization. Normally a gradient descent or gradient descent with momentum is employed. A challenge in using a conventional gradient descent-based approach is that the number of iterations of the gradient descent algorithm is typically quite large before an optimal point is reached. Consequently, the optimization process can take an undesirable length of time to perform.

This disclosure, and the exemplary embodiments described herein, describe methods and systems for accelerated optimization. The implementation described herein is related to systems and methods for implementation in various constrained, nonlinear optimization problems, however it is to be understood that the scope of this disclosure is not limited to such application.

### INCORPORATION BY REFERENCE

The following publications are incorporated by reference in their entirety.

[Ref. 1] I. M. Ross, An optimal control theory for nonlinear optimization, J. Comp. and Appl. Math., 354 (2019) 39-51.

[Ref. 2] R. B. Vinter, Optimal Control, Birkhäuser, Boston, Mass., 2000.

[Ref. 3] I. M. Ross, A Primer on Pontryagin's Principle in Optimal Control, second ed., Collegiate Publishers, San Francisco, Calif., 2015.

[Ref. 4] A. J. Krener, The high order Maximal Principle and its applications to singular extremals, SIAM J. of control and optimization, 15/2 (1977), 256-293.

[Ref. 5] F. Clarke, Lyapunov functions and feedback in nonlinear control. In: M. S. de Queiroz, M. Malisoff, P. Wolenski (eds) Optimal control, stabilization and nonsmooth analysis. Lecture Notes in Control and Information Science, vol 301. Springer, Berlin, Heidelberg (2004), 267-282.

[Ref. 6] F. Clarke, Nonsmooth analysis in systems and control theory. In: Meyers, R. A. (ed) Encyclopedia of Complexity and Systems Science. Springer, New York, N.Y. (2009), 6271-6285.

[Ref. 7] E. D. Sontag, Mathematical Control Theory: Deterministic Finite Dimensional Systems, second ed., Springer, New York, N.Y., 1998.

[Ref. 8] M. Motta, F. Rampazzo, Asymptotic controllability and Lyapunov-like functions determined by Lie brackets, SIAM J. Control and Optimization, 56/2, 2018, pp. 1508-1534.

[Ref. 9] R. A. Freeman, P. V. Kokotović, Optimal nonlinear controllers for feedback linearizable systems, Proc. ACC, Seattle, Wash., June 1995.

[Ref. 10] S. P. Bhat, D. S. Bernstein, Finite-time stability of continuous autonomous systems, SIAM J. Control Optim., 38/3, 2000, pp. 751-766.

[Ref. 11] P. Osinenko, P. Schmidt, S. Streif, Nonsmooth stabilization and its computational aspects, IFAC-PapersOnLine, 53/2, 2020, pp. 6370-6377.

[Ref. 12] H. Yamashita, A differential equation approach to nonlinear programming, Mathematical Programming, 18, 1980, pp. 155-168.

[Ref. 13] D. M. Murray, S. J. Yakowitz, The application of optimal control methodology to nonlinear programming problems. Math. Programming, 21/3, 1981, pp. 331-347.

[Ref. 14] A. A. Brown, M. C. Bartholomew-Biggs, ODE versus SQP methods for constrained optimization, J. optimization theory and applications, 62/3, 1989, pp. 371-386.

[Ref. 15] Yu. G. Evtushenko, V. G. Zhadan, Stable barrier-projection and barrier-Newton methods in nonlinear programming, Optim. Methods Software 3, 1994, pp. 237-256.

[Ref. 16] A. Bhaya, E. Kaszkurewicz, Control Perspectives on Numerical Algorithms and Matrix Problems, Advances in Design and Control, SIAM, Philadelphia, Pa., 2006.

[Ref. 17] L. Zhou, Y. Wu, L. Zhang, and G. Zhang, Convergence analysis of a differential equation approach for solving nonlinear programming problems, Appl. Math. Comput., 184, 2007, pp. 789-797.

[Ref. 18] I. Karafyllis, M. Krstic, Global Dynamical Solvers for Nonlinear Programming Problems, SIAM J. Control and Optimization, 55/2, 2017, pp. 1302-1331.

[Ref. 19] L. Lessard, B. Recht, A. Packard, Analysis and design of optimization algorithms via integral quadratic constraints, SIAM Journal on Optimization, 2016, 26(1), 5795.

[Ref. 20] W. Su, S. Boyd, E. J. Candes, A differential equation for modeling Nesterov's accelerated gradient method: theory and insights, J. machine learning research, 17 (2016) 1-43.

[Ref. 21] A. Wibisono, A. C. Wilson, M. I. Jordan, A variational perspective on accelerated methods in optimization, Proceedings of the National Academy of Sciences, 2016,133:E7351E7358.

[Ref. 22] B. S. Goh, Algorithms for unconstrained optimization via control theory, J. Optim. Theory Appl., 92/3, 1997, pp. 581-604.

[Ref. 23] M. S. Lee, H. G. Harno, B. S. Goh, K. H. Lim, On the bang-bang control approach via a component-wise line search strategy for unconstrained optimization, Numerical Algebra, Control and Optimization, 11/1,2021, pp. 45-61.

[Ref. 24] B. T. Polyak, Some methods of speeding up the convergence of iteration methods, USSR Computational Math. and Math. Phys., 4/5 (1964) 1-17 (Translated by H. F. Cleaves).

[Ref. 25] B. Polyak, P. Shcherbakov, Lyapunov functions: an optimization theory perspective, IFAC PapersOnLine, 50-1 (2017) 7456-7461.

[Ref. 26] Yu. E. Nesterov, A method of solving a convex programming problem with convergence rate O (1/k²), Soviet Math. Dokl., 27/2 (1983) 371-376 (Translated by A. Rosa).

[Ref. 27] P. T. Boggs, The solution of nonlinear system of equations by A-stable integration techniques, SIAM J. Numer. Anal. 8/4 (1971) 767-785.

[Ref. 28] M. K. Gavurin, Nonlinear functional equations and continuous analogues of iteration methods, lzv. Vyssh. Uchebn. Zaved. Mat., 5 (1958) 18-31.

[Ref. 29] A. A. Brown, M. C. Bartholomew-Biggs, ODE versus SQP methods for constrained optimization, J. optimization theory and applications, 62/3 (1989) 371-386.

[Ref. 30] L. Grüne, I. Karafyllis, Lyapunov Function Based Step Size Control for Numerical ODE Solvers with Application to Optimization Algorithms. In: K. Hüper, J. Trumpf (eds.) Mathematical System Theory, pp. 183-210 (2013) Festschrift in Honor of Uwe Helmke on the Occasion of his 60th Birthday.

[Ref. 31] F. H. Clarke, Yu. S. Ledyaev, and A. I. Subbotin. Universal feedback control via proximal aiming in problems of control under disturbances and differential games. Univ. de Montréal, Report CRM 2386,1994.

### BRIEF DESCRIPTION

In accordance with one exemplary embodiment of the present disclosure, disclosed is a method for processing digital representations of a group of objects and identifying within the group of objects a target object, the method including the execution of an accelerated optimization method to identify the target object within the digital representations of the group of objects , the accelerated optimization method comprising:
a) a user choosing a CLF V convergence condition; b) initializing the accelerated optimization method according to:

λₓ⁰=−∂ₓL (1, λₛ⁰, x⁰), s⁰=e (x⁰) and setting k=0;
c) computing Vₖ=V (z (k)); d) while stopping conditions are not met do; d1) generate ζ(k); d2) compute hₖ⁰; d3) advance to (z(k+1), x(k+1)) using hₖ⁰; d4) compute Vₖ₊₁=V(z(k+1)); d5) while Vₖ₊₁ has not decreased sufficiently do; d4a) backtrack (z(k+1), x(k+1)) along ζ(k); recompute Vₖ₊₁; d6) end while; and d7) update k←k+1; and e) end while.

In accordance with another exemplary embodiment of the present disclosure, disclosed is a method for modeling a device or process to generate a model based on a group of digital representations of the device or process characteristics, the method including the execution of an accelerated optimization method to classify the digital representations of the device or process associated with each digital representation, the accelerated optimization method comprising: a) a user choosing a CLF V convergence condition; b) initializing the accelerated optimization method according to: λₓ⁰−∂ₓL (1, λₛ⁰, x⁰), s⁰=e(x⁰) and setting k=0; c) computing Vₖ=V(z(k)); d) while stopping conditions are not met do; d1) generate ζ(k); d2) compute hₖ⁰; d3) advance to (z(k+1), x(k+1)) using hₖ⁰; d4) compute Vₖ₊₁=V(z(k+1)); d5) while Vₖ₊₁ has not decreased sufficiently do; d4a) backtrack (z(k+1), x(k+1)) along ζ(k); recompute Vₖ₊₁; d6) end while; and d7) update k←k+1; and e) end while.

In accordance with another exemplary embodiment of the present disclosure, disclosed is an apparatus for processing digital representations of a group of objects and identifying within the group of objects a target object, the apparatus including the execution of an accelerated optimization method to identify the target object within the digital representations of the group of objects , the accelerated optimization method comprising: a) a user choosing a CLF V convergence condition; b) initializing the accelerated optimization method according to: λₓ⁰=−∂ₓL(1, λₛ⁰, x⁰), s⁰=e(x⁰) and setting k=0; c) computing Vₖ=V(z(k)); d) while stopping conditions are not met do; d1) generate ζ(k); d2) compute hₖ⁰; d3) advance to (z(k+1), x(k+1)) using hₖ⁰; d4) compute Vₖ₊₁=V(z(k+1)); d5) while Vₖ₊₁ has not decreased sufficiently do; d4a) backtrack (z(k+1), x(k+1)) along ζ(k); recompute Vₖ₊₁; d6) end while; and d7) update k←k+1; and e) end while.

In accordance with another exemplary embodiment of the present disclosure, disclosed is a method for accelerating optimization, the method comprising: selecting a control Lyapunov function (CLF) and associated parameters for an optimization problem; generate an algorithm to solve the optimization problem according to λₓ⁰=∂ₓL (1, λₛ⁰, x⁰), s⁰=e(x⁰), where k is set to 0; until stopping conditions are reached: generating ζ(k) by solving the optimization problem; computing hₖ⁰ using at least one of a group consisting of

$${M}_{1} ( k ) = [ \begin{matrix}X \\ {h}_{k}^{BL}\end{matrix} ] + {h}_{k}^{BL} {M}_{2} ( k ) x = {b}_{k} ,$$

$${h}_{k}^{FE} = - \frac{{z}_{k}^{T} {QF}_{k}}{{f}_{k}^{T} {Qf}_{k}} = \frac{- {ℒ}_{f} V ( {z}_{k} )}{2 V ( {f}_{k} )} ,$$

$$and$$

$${h}_{k}^{tan} = \frac{V ( {z}_{k} )}{- {ℒ}_{f} V ( {z}_{k} )} ;$$

advancing to z(k+1), x(k+1)) using a three-step iterative map and hₖ⁰; computing Vₖ₊₁=V (z (k+1)); until Vₖ₊₁ has decreased to a target threshold, backtracking (z(k+1), x(k+1)) along ζ(k) and recomputing Vₖ₊₁; and incrementing k to the next step.

### BRIEF DESCRIPTION OF THE DRAWINGS

For a more complete understanding of the present disclosure, reference is now made to the following descriptions taken in conjunction with the accompanying drawings.

FIG. 1 is a diagram of an example artificial intelligence/machine learning method/system for the classification of a body of images, the classification process using an accelerated optimization method/system according to an exemplary embodiment of this disclosure.

FIG. 2 is a diagram of an example artificial intelligence/machine learning method/system application for the building of a model of a physical process from historical data, the model building process using an accelerated optimization method/system according to an exemplary embodiment of this disclosure.

FIG. 3 shows six iterations of a gradient algorithm based on Algorithm 5.1, i.e., Accelerated Optimization, according to an exemplary embodiment of this disclosure.

FIG. 4 shows six iterations of a standard gradient algorithm, without the use of Accelerated Optimization as disclosed herein.

FIG. 5 shows twelve iterations of a standard gradient algorithm, without the use of Accelerated Optimization as disclosed herein.

FIG. 6 shows eighteen iterations of a standard gradient algorithm, without the use of Accelerated Optimization as disclosed herein.

### DETAILED DESCRIPTION

This disclosure and exemplary embodiments described herein provide accelerated optimization for constrained, nonlinear optimization problems. The methods, apparatus, systems disclosed herein can be implemented in, for example, executable machine code and/or integrated circuit hardware. By acceleration, it is meant that an optimal point can be reached in a fewer number of iterations (viz. in a shorter length of time) than by using an optimization scheme that exists as part of the prior art.

The details of this disclosure, and the exemplary accelerated optimization embodiments provided, are described below where the main steps include:

```
Algorithm 5.1 Main
Choose a CLF V and the parameters associated with Problem (P) or
(P*)(cf. (3.12) and (3.14))
Initialize the algorithm according to: λₓ⁰ = −∂ₓL(1, λₛ⁰, x⁰), s⁰ = e(x⁰).
Set k = 0.
Compute Vₖ = V(z(k))
while stopping conditions are not met do
    Generate ζ(k) by solving Problem (P*)( or (P))
    Compute hₖ⁰ using any one of (5.6), (5.7) or (5.9)
    Advance to (z(k + 1), x(k + 1)) using (5.2) and hₖ⁰
    Compute Vₖ₊₁ = V(z(k + 1))
    while Vₖ₊₁ has not decreased sufficiently do
      Backtrack (z(k + 1), x(k + 1)) along ζ(k); recompute Vₖ₊₁
  end while
  Update k ← k + 1
end while
```

To further illustrate the advantage of the accelerated optimization method disclosed herein, suppose it is necessary to solve the following problem:

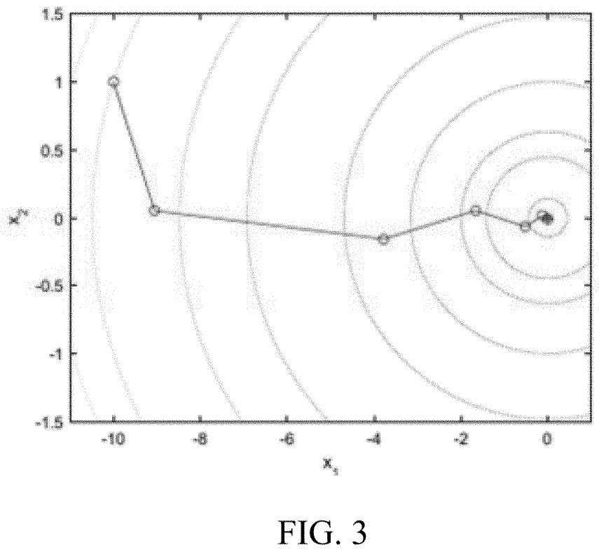

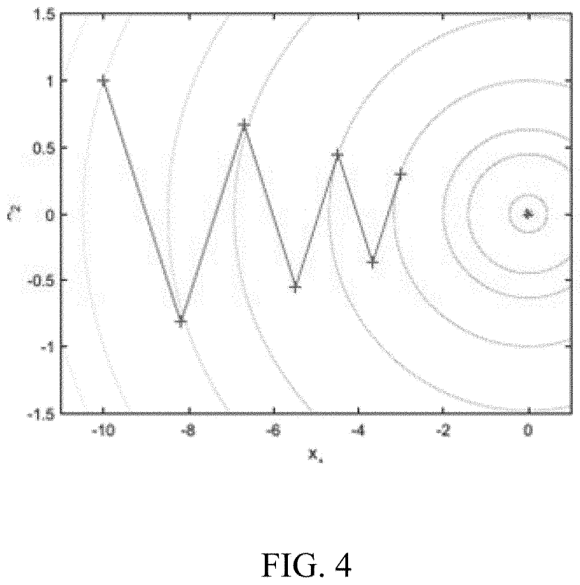

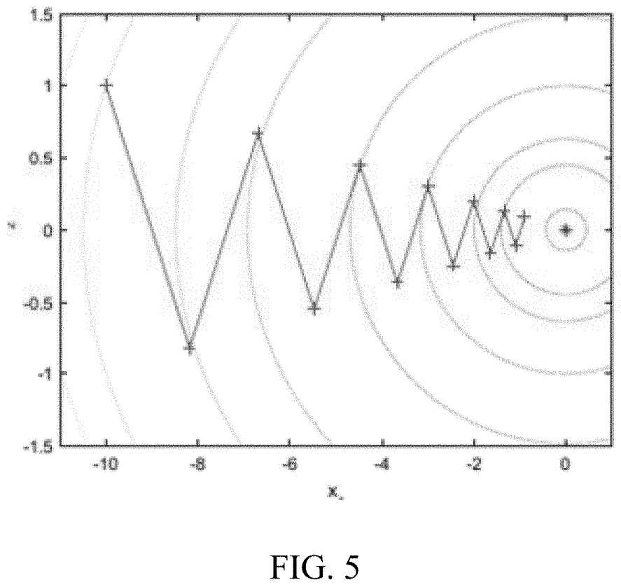

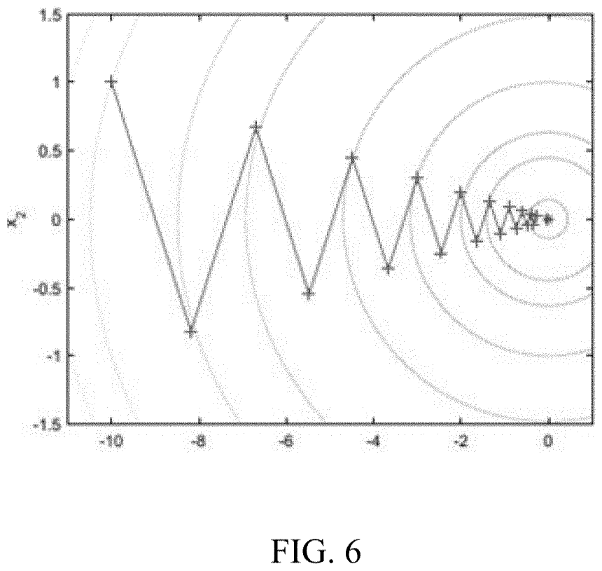

Minimize E=½*x_b 1\hat{ }2+5*x_2\hat{ }2

where (x1, x2) are the variable to be optimized. FIG. 3 shows 6 intermediate steps of the presently disclosed accelerated optimization method, where 6 iterations of a gradient algorithm are based on Algorithm 5.1. At the end of the sixth intermediate step the accelerated optimization is very close to the optimal point at (0,0). The first six intermediate steps of a prior art gradient method are shown in FIG. 4. Twelve iterations of a standard prior art gradient algorithm are shown in FIG. 5. As shown in FIG. 6, eighteen steps of a prior art gradient method are needed to reach an optimal point of (0,0). As shown in FIGS. 3-6, the method and apparatus for accelerated optimization disclosed herein can be used to advantageously reduce the number of iterations needed to solve a generic, constrained, nonlinear optimization problem.

As will be further described in further detail herein, to achieve accelerated optimization: the first-order optimality conditions for a generic nonlinear optimization problem are generated as part of the terminal transversality conditions of an optimal control problem. It is shown that the Lagrangian of the optimization problem is connected to the Hamiltonian of the optimal control problem via a zero-Hamiltonian, infinite-order, singular arc. The necessary conditions for the singular optimal control problem are used to produce an auxiliary controllable dynamical system whose trajectories generate algorithm primitives for the optimization problem. A three-step iterative map for a generic algorithm is designed by a semi-discretization step. Neither the feedback control law nor the differential equation governing the algorithm need be derived explicitly. A search direction is produced by a proximal-aiming-type method that dissipates a control Lyapunov function. New step size procedures based on minimizing control Lyapunov functions along a search vector complete the design of the accelerated algorithms.

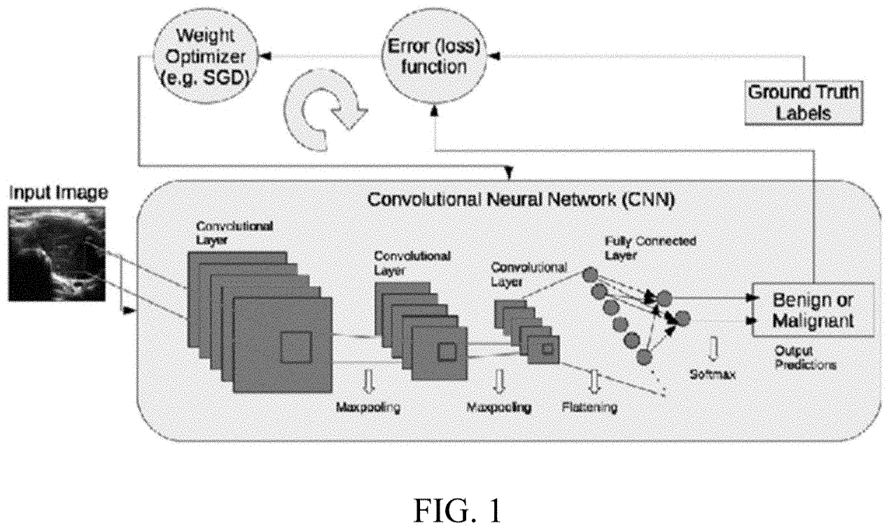

With reference to FIG. 1, illustrated is an exemplary artificial intelligence/machine learning related to classification of images which provides one application of the accelerate optimization method disclosed herein. Other application examples are possible. In the example illustrated, a machine learning process is used for classifying an input image as containing benign or malignant cells. In this application, a convolutional neural network is used to process the image pixels via a data transformation process involving convolution, maxpooling, flattening and softmax activation in order to predict, with a certain level of accuracy, whether the input image contains benign or malignant cells. In conventional practice, accuracy of the prediction is generally not 100%.

The accuracy of the prediction can be determined by comparing the output of the machine learning process against ground truth data. This allows an error (also known as loss) to be computed over a given data set. For example, the data set may be training data, validation data, test data, unseen data, etc. The specific equation(s) used to define the loss function depends on the application. Some typical examples are the root mean squared error or cross-entropy. Internal to the architecture of the machine learning agent (the CNN network in tis example), are various tunable weights whose values can be adjusted in order to reduce the value of the error. Tuning the weights is done be a weight optimizer which implements an optimization algorithm such as gradient descent, stochastic gradient descent, adaptive gradient algorithm, root mean square propagation, the ADAM algorithm, or other.

The overall performance of the trained artificial intelligence/machine learning process depends on the ability of the weight optimizer to tune the weights in a way that reduces the error. Not all algorithms give equivalent performance on reducing the error, viz. improving the accuracy of the artificial intelligence/machine learning process. For example, some weight optimization algorithms may give good error performance of a trained network, but may take a very long time (iterations, CPU time, wall-clock time, other) to perform the tuning process. Other weight optimization algorithms may perform the weight tuning process very quickly but yield larger errors (viz. less accurate predictions).

The method of the present disclosure is a new algorithm for performing a weight optimization task, for a method as shown in FIG. 1, more quickly (accelerated) and more accurately than the current state of the art. The process is described herein as Algorithm 5.1.

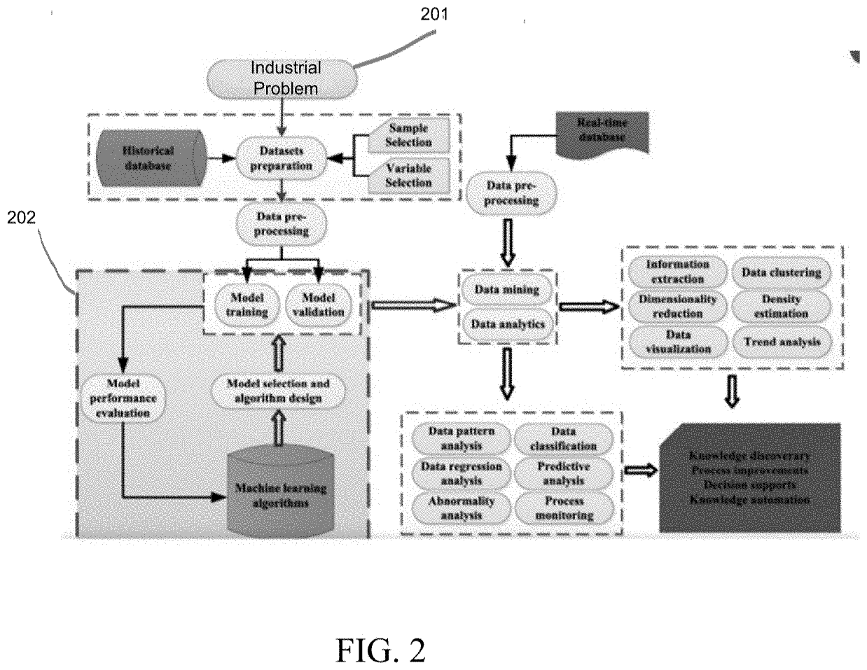

The flowchart shown in FIG. 2 illustrates a generic application area for an artificial intelligence/machine learning process. In FIG. 2, an artificial intelligence architecture, e.g., deep neural network, is depicted boxes 201 and 202. The artificial intelligence architecture takes one or more pre-processed datasets in order to build through a machine learning process a model of a physical process from historical data. The performance of a machine learning model is evaluated by comparing the model output against the truth data to compute an error or loss. The machine mearing model contains weights that can be tuned to reduce the error over a given data set. The weight tuning process is done by a weight optimization module which is labeled as ‘machine learning algorithms. The same weight optimization algorithms as before can be used in this context: gradient descent, stochastic gradient descent, adaptive gradient algorithm, root mean square propagation, the ADAM algorithm, or other.

According to an exemplary embodiment of this discloser, the method herein is a new algorithm for performing a weight optimization task, as shown in FIG. 2, of a generic artificial/machine learning process more quickly (accelerated) and more accurately than the current state of the art. The process is described as Algorithm 5.1.

The description that follows includes additional introductory material to further illustrate the background, details, and applications of the disclosed Accelerated Optimization Method and Apparatus.

### 1. Introduction.

Consider a generic, nonlinear optimization problem,

$$( N ) \{ \begin{matrix}{Minimize}_{{x}_{f} ∈ C ⊆ {ℝ}^{{N}_{x}}} & E ( {x}_{f} )\end{matrix} \qquad ( 1.1 )$$

where, E: [symbol] ^{N}^{ₓ} [symbol] x_{f} [symbol] [symbol] is an objective function, C is a constraint set in [symbol] ^{N}^{ₓ}and Nₓ∈ [symbol] ⁺.

The first-order optimality condition for Problem (N) is given by,

0 ∈v_{f}⁰ ∂E(xⱼ)+N_{C} (x_{f}) (1.2)

where, v_{f}⁰≥0 is a Fritz John cost multiplier and N_{C} (x_{f}) is the (limiting) normal cone to C at x_{f}. Now consider the following optimal control problem,

$$( {M}^{′} ) \{ \begin{matrix}Minimize & J [ x ( \cdot ) , u ( \cdot ) , {t}_{f} ] := E ( x ( {t}_{f} ) ) \\ Subject to & \dot{x} = {f}^{′} ( x , {u}^{′} , t ) \\ & ( x ( {t}_{0} ) , {t}_{0} ) = ( {x}^{0} , {t}^{0} ) \\ & x ( {t}_{f} ) = C\end{matrix} \qquad ( 1.3 )$$

where, u′∈ [symbol] ^{N}^{ᵤ} is a control variable, f′: [symbol] ^{N}^{ₓ}× [symbol] ^{N}^{ᵤ}× [symbol] → [symbol] ^{N}^{ₓ} is some given dynamics function, t ∈ [symbol] is an independent “time” variable and (x⁰, t⁰) is a given initial point in [symbol] ^{N}^{ₓ}× [symbol] . The terminal transversality condition for Problem (M′) is given by,

λ′(t_{f}) ∈ v₀ ∂E(x(t_{f}))+N_{C}(x(t_{f})) (1.4)

where, t_{f} is the final time, λ′(t_{f}) ∈ [symbol] ^{N}^{ₓ} is the final-time value of the adjoint covector and v₀ is the cost multiplier associated with (1.3). Motivated by intellectual curiosity, a question posed in [1] was: Does an optimal control problem (M′)=(M) exist such that λ′(t_{f})=0 ? Needless to say, this question was answered in the affirmative for the case when C is given by functional constraints,

C={x ∈ [symbol] ^{N}^{ₓ}: e^{L}≤e(x)≤e^{U}} (1.5)

where, e: x [symbol] [symbol] ^{N}^{ₑ}, Nₑ ∈ [symbol] is a given function, and e^{L} and e^{U} are the specified lower and upper bounds on the values of e. Furthermore, the existence of Problem (M) was proved in [Ref. 1] by direct construction. No claim is staked on the uniqueness of such a problem. In fact, the absence of uniqueness is utilized in this disclosure to devise another Problem (M) (in Section 2) that solves Problem (N).

It is apparent that the trajectory, t [symbol] x(t), generated by Problem (M) is an “algorithm” for solving Problem (N), where x(t₀)=x⁰ is the initial point or a guess to a solution for Problem (N). This observation implies that the traditional concept of an algorithm as a countable sequence generated by the point-to-set map,

x⁰ [symbol] {x⁰=x₀, x₁, . . . , xₖ, xₖ₊₁, . . . } (1.6)

be upgraded to its more primitive form:

x⁰ [symbol] {x⁰=x(t₀), (t₀, ∞) [symbol] t [symbol] x(t)} (1.7)

DEFINITION 1.1 (Algorithm Primitive). Equation (1.7) is an algorithm primitive for Problem (N). A suitable discretization of (1.7) generates an algorithm given by,

x⁰ [symbol] {x⁰=x(t₀), x(t₁), . . . , x(tₖ), x(tₖ₊₁), . . . } (1.8)

Suppose that an algorithm primitive is steerable by its tangent vector; then, we can write,

\dot{x}=u (1.9)

as a key equation that must constitute the vector field that defines Problem (M). Although it was motivated by trajectory arguments, it is evident from a forward Euler discretization of (1.9) that u is, in fact, a continuous-time version of the search vector in optimization.

Note, however, that (1.9) was not “derived” by considering the limit of a vanishing step size in optimization. In fact, it will be apparent later (in Section 5) that there is a difference between a Eulerian and an optimization step-size.

Equation (1.9) was used in [Ref. 1] to independently derive various algorithms such as the gradient and Newton's method. Accelerated optimization algorithms appeared to be beyond the reach of the theory proposed in [Ref.1]; however, it was conjectured that such methods may be derivable by simply replacing (1.9) by the double integrator model,

\ddot{x}→u (1.10)

The main contribution of this disclosure is in proving this conjecture. A major consequence of this proof is a new approach to designing accelerated optimization algorithms.

REMARK 1.2. From an optimal control perspective, the difference between (1.9) and (1.10) seems quite trivial because the former implies x(·) ∈ W^{1,1} ([t₀, t_{f}], [symbol] ^{N}^{ₓ}) while the latter indicates x(·) ∈ W^{2,1}([t₀, t_{f}], [symbol] ^{N}^{ₓ})[Ref.2]. Nonetheless, as will be apparent in the sections to follow, the ramifications of x(·) being an element of a smoother function space appear to have an outsized effect with regards to the problem of generating algorithms for solving Problem (N). From an optimization perspective, the differences between (1.9) and (1.10) is a little more nuanced: the search vector in (1.9) steers the tangent vector (i.e., \dot{x}) whereas u in (1.10) steers the rate of change of the tangent vector. Because the rate of change of the tangent vector implicitly incorporates prior information, the source of acceleration from the perspective of the algorithm primitive (i.e., t [symbol] x(t)) is in using this additional information to propel it forward. An interesting consequence of this observation is that algorithmic acceleration is indeed achieved by controlling acceleration (i.e.,\ddot{x}).

2. A Transversality Mapping Principle. With C given by (1.5), the Lagrangian function for the nonlinear programming (NLP) Problem (N) may be written as,

L(v_{f}⁰, v_{f}, x_{f}):=v_{f}⁰E(x_{f})+v_{f}·e(x_{f}) (2.1)

where, (v_{f}⁰, v_{f}) ∈ [symbol] ₊ x∈ [symbol] ^{N}^{ₑ} is the Fritz John multiplier pair, with v_{f} satisfying the complementarity condition, denoted by (v_{f} †e(x_{f})), and given by,

$${v}_{f} †e ( {x}_{f} ) ⇔ {v}_{i} \{ \begin{matrix}\leq 0 & if & {e}_{i} ( {x}_{f} ) = {e}_{i}^{L} \\ = 0 & if & {e}_{i}^{L} < {e}_{i} ( {x}_{f} ) < {e}_{i}^{U} \\ \geq 0 & if & {e}_{i} ( {x}_{f} ) = {e}_{i}^{U} \\ unrestricted & if & {e}_{i}^{L} = {e}_{i}^{U}\end{matrix} \qquad ( 2.2 )$$

where, i=1, . . . , Nₓ. Together with (2.2), the first-order optimality condition for Problem (N) is given by,

0=∂ₓL(v_{f}⁰, v_{f}, xⱼ) (2.3)

To construct Problem (M), [Ref.1] is followed by “sweeping back in time” the data functions E and e to define functions t [symbol] y∈ [symbol] and t [symbol] s∈ [symbol] ^{N}^{ₑ} according to,

y(t):=E(x(t)) (2.4a)

s(t):=e(x(t)) (2.4b)

Differentiating (2.4) with respect to time gets,

\dot{y}=[∂ₓE(x)]·v (2.5b)

\dot{s}=[∂ₓe(x)]v (2.5b)

where, \dot{x}:=v is set as the “velocity” variable. Collecting all relevant equations, the following time-free optimal control problem is constructed:

$$( M ) \{ \begin{matrix}Minimize & J [ x ( \cdot ) , v ( \cdot ) , y ( \cdot ) , s ( \cdot ) , u ( \cdot ) , {t}_{f} ] := y ( {t}_{f} ) \\ Subject to & \dot{x} = v \\ & \dot{v} = u \\ & \dot{y} = [ {\partial }_{x} E ( x ) ] \cdot v \\ & \dot{s} = [ {\partial }_{x} e ( x ) ] v \\ & ( x ( {t}_{0} ) , {t}_{0} ) \\ & ( y ( {t}_{0} ) , s ( {t}_{0} ) ) = ( E ( {x}^{0} ) , e ( {x}^{0} ) ) \\ & v ( {t}_{f} ) = 0 \\ & {e}^{L} \leq s ( {t}_{f} ) \leq {e}^{U}\end{matrix} \qquad ( 2.6 )$$

REMARK 2.1. Problem (N) is embedded in Problem (M). This follows from (2.4) and the imposition of the final-time constraint on s(t) in (2.6). Furthermore, a solution to Problem (M) generates an algorithm primitive for Problem (N).

The Pontryagin Hamiltonian [Ref. 2 and 3] for Problem (M) is given by,

H(λₓ, λᵥ, λ_{y}, λₛ, x, v, y, s, u):=λₓ·v+λᵥ·u+λ_{y} [∂ₓ E(x)]·v+λₛ·[∂ₓe(x)]v (2.7)

where λₓ, λᵥ, λ_{y} and λₛ are the adjoint covectors corresponding to the dynamics associated with the variables x, v, y and s respectively.

LEMMA 2.2. The Pontryagin Hamiltonian for Problem (M) and the instantaneous Lagrangian function associated with Problem (N) satisfy the condition,

H (λₓ, λᵥ, λ_{y}, λₛ, x, v, y, s, u):=[λₓ+∂ₓL(λ_{y}, λₛ, x)]·v+λᵥ·u (2.8)

PROOF. This follows directly from the defining equations given by (2.1) and (2.7).

PROPOSITION 2.3. The adjoint arc t [symbol] (λₓ, λᵥ, λ_{y}, λₛ) evolves according to,

λₓ(t)=−∂ₓL(λ_{y}(t), λₛ(t), x(t))+cₓ (2.9a)

λᵥ(t)=−cₓ (t−t₀)+cᵥ (2.9b)

λ_{y} (t)=c_{y} (2.9c)

λₛ (t)=cₛ (2.9d)

where, (cₓ, cᵥ, c_{y}, cₛ)∈ [symbol] ^{N}^{ₓ}× [symbol] ^{N}^{ₓ}× [symbol] × [symbol] ^{N}^{ₑ} is a constant,

PROOF. The adjoint equations are given by,

\dot{λ} ₓ:=∂ₓH=−[∂ₓ²L(λ_{y}, λₛ, x)]v (2.10a)

\dot{λ} ᵥ:=−∂ᵥH=−λₓ−∂ₓL(λ_{y}, λₛ, x) (2.10b)

\dot{λ} _{y}:=−∂_{y}H=0 (2.10c)

\dot{λ} ₛ:=−∂ₛH=0 (2,10(1)

Equations (2.9c) and (2.9d) follow directly from (2.10c) and (2.10d), respectively.

Substituting v=\dot{x} in (2.10a), it follows that,

$${\dot{λ}}_{x} = - \frac{d}{dt} [ {\partial }_{x} L ( {λ}_{y} , {λ}_{s} , x ) ] + {\dot{λ}}_{y} {\partial }_{x} E ( x ) + {\sum }_{i = 1}^{{N}_{e}} {\dot{λ}}_{s} {\partial }_{x} {e}_{i} ( x ) \qquad ( 2.11 )$$

Equation (2.9a) follows from (2.11), (2.10c) and (2.10d). Substituting (2.9a) in (2.10b) provides.

λᵥ=−cₓ (2.12)

from which (2.9b) follows.

THEOREM 2.4. All extremals of Problem (M) are zero-Hamiltonian singular arcs. All singular arcs of Problem (M) are of infinite order.

Proof. From the Hamiltonian minimization condition, the first-order condition is,

∂ᵤH(λₓ, λᵥ, λ_{y}, λₛ, x, v, y, s, u)=0⇒λᵥ=0 ∀t ∈[t₀, t_{f}] (2.13)

Thus, all extremals are singular. From PROPOSITION 2.3 and (2.13), cₓ=0; hence,

λₓ(t)=−∂ₓL(λ_{y}(t), λₛ (t), x(t)) (2.14)

The first part of the theorem now follows from LEMMA 2.2. To prove the second part, differentiate dull with respect to time:

$$\frac{d}{dt} {\partial }_{u} H = {\dot{λ}}_{v} = - {λ}_{x} - {\partial }_{x} L ( {λ}_{y} , {λ}_{s} , x ) \qquad ( 2.15 )$$

The second equality in (2.15) follows from (2.10b). Differentiating (2.15) with respect to time provides,

$$\frac{{d}^{2}}{{dt}^{2}} {\partial }_{u} H = {\ddot{λ}}_{v} = - {\dot{λ}}_{x} - \frac{d}{dt} {\partial }_{x} L ( {λ}_{y} , {λ}_{s} , x ) = - {\dot{λ}}_{y} {\partial }_{x} E ( x ) - {\sum }_{i = 1}^{{N}_{e}} {\dot{λ}}_{s} {\partial }_{x} {e}_{i} ( x ) \qquad ( 2.16 )$$

where, the last equality follows from (2.11). Substituting (2.10c) and (2.10d) in (2.16), provides,

$$\frac{{d}^{2}}{{dt}^{2}} {\partial }_{u} H ≡ 0 \qquad ( 2.17 )$$

$$∀ t ∈ [ {t}_{0} , {t}_{f} ]$$

$$Hence ,$$

$$\frac{{d}^{k}}{{dt}^{k}} {\partial }_{u} H = 0$$

$$for$$

$$k = 0 , 1 …$$

and no k yields an expression for u.
The endpoint Lagrangian [Ref. 3] associated with the final-time conditions of Problem (M) may be written as,

E(v₀, vₛ, y(t_{f}), v(t_{f}), v(t_{f}), y(t_{f}), s(t_{f})):=v₀y(t_{f})+vᵥ·v(t_{f})+vₛ·s(t_{f}) (2.18)

where, v₀≥0 is the cost multiplier, vᵥ ∈ [symbol] ^{N}^{ₓ} and vₛ satisfies the complementarity condition,

$${v}_{s} † s ( {t}_{f} ) ⇔ {v}_{s , i} \{ \begin{matrix}\leq 0 & if & {s}_{i} ( {t}_{f} ) & = {e}_{i}^{L} \\ = 0 & if & {e}_{i}^{L} < {s}_{i} ( {t}_{f} ) & < {e}_{i}^{U} \\ \geq 0 & if & {s}_{i} ( {t}_{f} ) & = {e}_{i}^{U} \\ unrestricted & if & {e}_{i}^{L} & = {e}_{i}^{U}\end{matrix}$$

Thus, the terminal transversality conditions for Problem (M) are given by,

λₛ (t_{f})=0 (2.20a)

λᵥ (t_{f})=vᵥ (2.20b)

λ_{y} (t_{f})=v₀≥0 (2.20c)

λₛ (t_{f})=vₛ (2.20d)

It is straightforward to show that the initial transversality generates the condition λᵥ(t₀)=0; hence, vᵥ=0.

THEOREM 2.5 (Transversality Mapping Principle (TMP)). The first-order necessary conditions for Problem (N) are imbedded in the terminal transversality conditions for Problem (M).

PROOF. From Theorem 2.4 (Cf. (2.14)) and (2.20a) provides,

0=∂ₓ L(λ_{y} (t_{f}), λₛ (t_{f}), x(t_{f})) (2.21)

Substituting (2.20c) and (2.20d) in (2.21) gets the result (i.e., (2.3) and (2.2)) with the following mapping of the multipliers,

v_{f}⁰↔v₀=λ_{y} (t_{f}) (2.22a)

v_{f}↔vₛ=λₛ (f_{f}) (2.22b)

REMARK 2.6. THEOREM 2.5 is an extension of the TMP presented in [Ref.1]. Also, PROPOSITION 2.3 provides additional clarification and details that are absent in [Ref.1].

3. New Principles for Accelerated Optimization. Because the extremals of Problem (M) are singular arcs of infinite order (Cf. Theorem 2.4), neither Pontryagin's Principle nor Krener's high order maximum principle [Ref.4] provide a computational mechanism for producing a singular optimal control. Consequently, new ideas are developed for computation.

Collecting all the relevant primal-dual differential equations from Section 2 together with their boundary conditions generates the following unconventional boundary value problem,

\dot{x}=v

\dot{λ} ₓ=−[∂ₓ²L (λ_{y}, λₛ, x)]v (3.1a)

\dot{v}=u

\dot{λ} ᵥ=−λₓ−∂ₓL(λ_{y}, λₛ, x) (3.1b)

\dot{y}=[∂ₓ E(x)]·v

\dot{λ} _{y}=0 (3.1c)

\dot{s}=[∂ₓe(x)]v

\dot{λ} ₛ=0 (3.1d)

x(t₀)=x⁰

λₓ(t_{f})=0 (3.1e)

y(t₀)=E(x⁰)

λ_{y} (t_{f})≥0 (3.1f)

s(t₀)=e(x⁰)

λₛ (t_{f})†s(t_{f}) (3.1g)

λᵥ (t₀=0

v(t_{f})=0 (3.1h)

e^{L}≤s(t_{f}≤e^{U} (3.1i)

Any infinite-order singular control trajectory u(·) that solves (3.1) also solves Problem (M). Consequently, such a solution generates an algorithm primitive that solves Problem (N). To produce such an algorithm primitive, the ideas proposed in [Ref.1] are followed and extended by using the sweeping principle to inject dual control variables. That is, as in [Ref.1], the equation \dot{λ} ₛ=0 is replace by introducing a control variable μ that steers λₛ(t):

\dot{λ} ₛ=μ (3.2)

### Similarly, set is,

\dot{λ} _{y}=ω (3.3)

In the unaccelerated version of this theory [Ref.1], it was important modify the adjoint equation (corresponding to x) to maintain a zero-Hamiltonian singular trajectory (Cf. Theorem 2.4). Adopting the same idea, the adjoint equation is modified according to,

−\dot{λ} ₓ=[∂ₓ²L(λ_{y}, λₛ, x)]v+∂ₓL (107 , μ, x) (3.4)

Equation (3.4) is simply the time derivative of (2.14). Consequently, (3.4) also ensures that \dot{λ} ᵥ=0∀t ∈[t₀, t_{f}] (Cf. (2.10 b)); hence, λᵥ can be safely eliminated in generating a singular solution to (3.1). Thus, the problem of generating a candidate infinite-order singular arc to Problem (M) reduces to a controllability-type problem associated with the following auxiliary primal-dual system,

$$( A ) \{ \begin{matrix}{\dot{λ}}_{x} = - [ {\partial }_{x}^{2} L ( {λ}_{y} , {λ}_{s} , x ) ] v - {\partial }_{x} L ( ω , μ , x ) \\ {\dot{λ}}_{y} = ω \\ {\dot{λ}}_{s} = μ \\ \dot{v} = u \\ \dot{s} = [ {\partial }_{x} e ( x ) ] v\end{matrix} \qquad ( 3.5 )$$

The final-time conditions for (A) are extracted from (3.1) and can be specified in terms of the target set, T given by,

T:={λₓ (t_{f}), λ_{y} (t_{f}), λₛ (t_{f}), v (t_{f}), s(t_{f})|λₓ (t_{f})=0, λ_{y} (t_{f})≥0, λₛ (t_{f}) †s(t_{f}), v(t_{f})=0, e^{L}≤s(t_{f})≤e^{U}} (3.6)

In the discussions to follow, it will be convenient to view the dynamical system (A) in terms of the sum of two vector fields: where,

z:=(λₓ, λ_{y}, λₛ, v, s)

ζ:=(u, μ, ω) (3.8a)

f₀≡f₀ (λ_{y}, λₛ, v, x)

f₁≡f₁ (x, ζ) (3.8b)

In control theory, f₀ is known as the drift vector field, whose presence (or absence) impact the production of solutions to the (A)-(T) system. In the unaccelerated version of this theory, there is no drift vector field [Ref.1]; hence, an extension of the ideas to accelerated optimization requires an explicit consideration of f₀.

The main problem of interest with respect to generating an algorithm primitive for solving Problem (N) can now be framed as finding the control function t [symbol] ζ that drives a given point, T^{c} [symbol] z⁰=z (t₀), to some point z(t_{f}) ∈ T, where, T^{c} is the complement of T. To formalize the statement of this problem, Clarke's notion of guidability [Ref. 5 and 6] is adopted:

DEFINITION 3.1 (Guidability). A point z⁰ ∈ T^{c} is guidable to T if there is a trajectory [t₀, t_{f}]→z(t) satisfying z(t₀)=z⁰ and z(t_{f}) ∈ T.

DEFINITION 3.2 (Global Guidability). A point z⁰ ∈ T^{c} is globally guidable to T if every point z⁰ ∈ T^{c} is guidable to T.

DEFINITION 3.3 (Asymptotic Guidability). A point z⁰ is asymptotically guidable to T if it is guidable with t_{f}→∞.

It is apparent that the notion of guidability is weaker than stability. Furthermore, it is clear that guidability is quite sufficient in terms of producing an algorithm primitive to solve Problem (N).

To design algorithm primitives for Problem (N), needed are guidable trajectories for the (A)-(T) pair. A standard workhorse in control theory for solving such a problem is a control Lyapunov function (CLF) [Ref.5 and 7]. Following [Ref.8], a CLF is defined for the (A)-(T) system as a positive definite function, V: T̅^̅{̅c̅}̅→ [symbol] , such that for each point in T^{c}, there exists a value of f that points in a direction along which V is strictly decreasing. Let £_{f}V be the Lie derivative of V along the vector field f. Then the strict decreasing condition can be expressed as,

£_{f}V:= [symbol] ∂V(z), f(λ_{y}, λₛ, v, x, ζ) [symbol] <0 (3.9)

for some choice of ζ. Because it is possible for £_{f}_{₁} V to vanish for all choices of ζ (see (3.7)) when z ∈ T^{c}, a satisfaction of (3.9) requires the condition,

£_{f}_{₀} VL= [symbol] ∂V (z), f₀ (λ_{y}, λₛ, v, x) [symbol] <0 if £_{f}_{₁}V=0 (3.10)

whenever z ∉ T.

As a means to get the best instantaneous solution, controls are chosen such that.

$$ζ = arg {min}_{ζ} {ℒ}_{f} V \qquad ( 3.11 )$$

One problem with (3.11) is that EfV is an affine function of ζ and the control is unbounded. Hence, to use (3.11) in a meaningful manner, it is necessary to constrain ζ to some compact set [symbol] . This notion is similar to that of a trust region in optimization; however, as shown in [Ref.1], a proper choice for [symbol] also generates new insights on the selection of a metric space for an optimization algorithm. Hence, the idea implicit in (3.11) is framed in terms of the following minimum principle:

$$( P ) \{ \begin{matrix}{Minimize}_{ζ} & {ℒ}_{f} V := 〈 \partial V ( z ) , f ( {λ}_{y} , {λ}_{s} , v , x , ζ ) 〉 \\ Subject to & ζ ∈ ( z , x , y , t )\end{matrix} \qquad ( 3.12 )$$

where, [symbol] (z,x,y,t) is any given compact set that may vary with respect to the tuple (z, x, y, t); i.e., [symbol] : (z, x, y, t)→ [symbol] ^{N}^{ₓ}× [symbol] ^{N}^{ₑ}× [symbol] . Equation (3.12) is a direct extension of the minimum principle posed in [Ref.1]. The caveat in applying (3.12) is an assurance of (3.10).

In exploring a different method to manage the drift vector field, exchanged are the cost function and constraint condition in (3.12) to formulate an alternative minimum principle that holds the potential to provide additional insights in formulating optimal algorithm primitives. To facilitate this development, ρ:(z,x,y,t) [symbol] [symbol] ₊ tis selected o be some function such that −ρ specifies a rate of descent for £_{f}V. That is, (3.9) is replaced by the constraint,

∃ζs,t, £_{f}V:= [symbol] ∂V(z), f(λ_{y}, λₛ, v, x, ζ [symbol] ≤−ρ(z,x,y,t) (3.13)

Let D: (ζ, z, x, y, t) [symbol] [symbol] be an appropriate objective function. Then, an alternative minimum principle may be posed as:

$$( {P}^{*} ) \{ \begin{matrix}{Minimize}_{ζ} & D ( ζ , z , x , y , t ) \\ Subject to & {ℒ}_{F} V + ρ ( z , x , y , t ) \leq 0\end{matrix} \qquad ( 3.14 )$$

An apparently obvious choice for ρ in (3.14) is V itself because it would imply that the resulting Lyapunov function would decrease at least exponentially. As fast as an exponential might be, it turns out a better choice for ρ may be possible if the minimum principles (P) and (P*) are viewed as merely computational techniques to solve the CLF inequality [Ref.5],

$${min}_{ζ ∈} {ℒ}_{f} V + ρ ( z , x , y , t ) \leq 0 \qquad ( 3.15 )$$

As is well documented [Ref. 5,8, and 11], what is most interesting about (3.15) is that it can be rewritten as a Hamilton-Jacobi-Bellman (HJB) inequality,

$${m in}_{ζ ∈} {H}^{P} ( \partial V , z , x , ζ ) + ρ ( z , x , y , t ) \leq 0 \qquad ( 3.16 )$$

where, H^{P} (λ^{A},z,x,ζ):= [symbol] λ^{A}, f(λ_{y}, λₛ,v,x,ζ) [symbol] may be viewed as the Pontryagin Hamiltonian for System (A). Evidently, even a minimum-time solution can be produced if V is chosen as the time-to-go function [Ref.5]. Because such “optimal functions” are unknown, a more tractable approach to selecting ρ is provided by the following theorem due to Bhat and Bernstein[10]:

Theorem 3.4 (Bhat-Bernstein). Let ρ be given by,

ρ(z):=r(V(z))^{1-m} (3.17)

where r>0 and m ∈ (0,1). Then, the the time interval for a guidable trajectory [t₀, t_{f}] [symbol] z is bounded by

$$( {t}_{f} - {t}_{0} ) \leq \frac{{( V ( {z}^{0} ) )}^{m}}{rm} \qquad ( 3.18 )$$

REMARK 3.5. It is apparent that the “left” limiting case of m→0 in Theorem 3.4 corresponds to the case of asymptotic guidability while the “right” limiting case of m→1 may be viewed as a solution to a minimum-time problem provided V is chosen as the time-to-go function [Ref. 5].

REMARK 3.6. Based on the connections between the HJB equations and a CLF as a computational method for selecting ζ, the minimum principles (P) and (P*) may be viewed as Pontryagin-type conditions for an optimal control of System (A).

The minimum principles (P) and (P*) are technically not new. They have been widely used in control theory for generating feedback controls [Refs. 5, 7, 8, and 9] . What makes them new in (3.12) and (3.14) is their specific use for the (A, T) pair, and consequently, in designing ordinary differential equations (ODEs) that generate algorithm primitives (cf. (1.7)). Furthermore, recall that the (A, T) system was derived from the necessary conditions of Problem (M) with the TMP providing the critical link (Cf. THEOREM 2.5) between Problems (M) and (N). These ideas are in sharp contrast to earlier works [Refs. 12-18] that have sought to solve NLPs using differential equations. Consequently, the differential equations proposed in these prior works are not only different from (3.5), but also (3.5) is used as generators of ODEs. Furthermore, the CLFs used in (3.12) and (3.14) are generic; hence, different choices of V can lead to different ODEs, which, in turn generate different algorithm primitives. Finally, note also that the focus of this current discussion is primarily on accelerated optimization.

In the absence of additional analysis, it might appear that we have come to full circle; i.e., in the quest for solving NLPs via optimal control theory, generated Problems (P) and (P*) appear to be NLPs themselves. As a result, the proposed theory would only be meaningful if (a) it leads to some new insights on solving Problem (N) and/or (b) Problems (P) and (P*) were simpler than (N). Because the unaccelerated version of this theory[1] did indeed generate new insights, the same can be expected in pursuing this idea further. This is shown in Section 4. In addition, because System (A) is affine in the control variable, Problems (P) and (P*) can indeed be rendered simpler than (N). In this context, noted is that the structure of the vector field f can be further altered quite easily through the process of adding more integrators. For example, analogous to (1.10), λₛ=μ and λ_{y}=ω are replaced by,

\dot{λ} ₛ=θₛ, \dot{θ} ₛ=ωₛ (3.19)

\dot{λ} _{y}=θ_{y}, \dot{θ} _{y}=ω_{y} (3.20) to generate a new (A,T) pair:

$$( {A}^{′} ) \{ \begin{matrix}{\dot{λ}}_{x} = - [ {\partial }_{x}^{2} L ( {λ}_{y} , {λ}_{s} , x ) ] v - {\partial }_{x} L ( {θ}_{y} , {θ}_{s} , x ) \\ {\dot{λ}}_{y} = {θ}_{y} \\ {\dot{θ}}_{y} = {ω}_{y} \\ {\dot{λ}}_{s} = {θ}_{s} \\ {\dot{θ}}_{s} = {ω}_{s} \\ \dot{v} = u \\ \dot{s} = [ {\partial }_{x} e ( x ) ] v\end{matrix} \\ ( {T}^{′} ) \{ \begin{matrix}{λ}_{x} ( {t}_{f} ) \geq 0 \\ {λ}_{y} ( {t}_{f} ) \geq 0 \\ {θ}_{y} ( {t}_{f} ) = 0 \\ {θ}_{s} ( {t}_{f} ) = 0 \\ v ( {t}_{f} ) = 0 \\ {e}^{L} \leq s ( {t}_{f} ) \leq {e}^{U} \\ {λ}_{s} ( {t}_{f} ) † s ( {t}_{f} ) {λ}_{x} ( {t}_{f} ) = 0\end{matrix} \qquad ( 3.21 )$$

As noted earlier (Cf. REMARK 1.2), the addition of integrators seems to have a profound effect on the production of accelerated algorithms.

4. Generation of Accelerated Algorithm Primitives Illustrated. To illustrate some specific features of the general theory presented in Section 2 and Section 3, consider the unconstrained optimization problem,

$$( S ) \{ {Minimize}_{{x}_{f} ∈ {{N}_{x}}^{}} E ( {x}_{f} ) \qquad ( 4.1 )$$

Producing accelerated algorithms for such problems have generated increased attention in recent years [Refs. 19,20 and21] due to their immediate applicability to machine learning.

4.1. Development of the Auxiliary System. From Section 2, it follows that the optimal control problem that solves Problem (S) is given by:

$$( R ) \{ \begin{matrix}Minimize & J [ y ( \cdot ) , x ( \cdot ) , v ( \cdot ) , u ( \cdot ) , {t}_{f} ) := & {y}_{f} \\ Subject to & \dot{x} = & v \\ & \dot{v} = & u \\ & \dot{y} = & [ {\partial }_{x} E ( x ) ] \cdot v \\ & ( x ( {t}_{0} ) , {t}_{0} ) = & ( {x}^{0} , {t}^{0} ) \\ & y ( {t}_{0} ) = & E ( {x}^{0} ) \\ & v ( {t}_{f} ) = & 0\end{matrix} \qquad ( 4.2 )$$

REMARK 4.1. The unaccelerated version of Problem (R) (i.e., one without the velocity variable, v) was first formulated by Goh [Ref. 22]; however, because the problem is singular (cf. Theorem 2.4), Goh et al. [Ref. 23] advanced an alternative theory based on bang-bang controls by adding control constraints to (the unaccelerated version of) Problem (R).

PROPOSITION 4.2. PROBLEM (R) has no abnormal extremals.

PROOF. This proof is straightforward; hence, it is omitted. It is straightforward to show that (3.1) reduces to,

\dot{x}=v

\dot{λ} ᵥ=−λ_{z}−λₓ−λ_{y} ∂ₓE(x) (4.3a)

\dot{v}=u

\dot{λ} ᵥ=−λₓ−λ_{y} ∂ₓE(x) (4.3b)

\dot{y}=[∂ₓE(x)]^{T}v

\dot{λ} _{y}=0 (4.3c)

x(t⁰)=x⁰

v(t_{f})=0 (4.3d)

y(t⁰=E(x⁰)

λₓ(t_{f})=0 (4.3e)

λᵥ(⁰)=0

λ_{y} (t_{f})>0 (4.3f)

It thus follows that the auxiliary primal-dual dynamical system is given by,

$$( {A}_{R} ) \{ \begin{matrix}{\dot{λ}}_{x} = - {\partial }_{x}^{2} E ( x ) v \\ \dot{v} = u\end{matrix} \qquad ( 4.4 )$$

where, the adjoint convector is scaled by the constant, λ_{y}>0 (Cf. PROPOSITION 4.2).

The target final-time condition for (A_{R}) is given by,

$$( {T}_{R} ) = \{ \begin{matrix}{λ}_{x} ( {t}_{f} ) = 0 \\ v ( {t}_{f} ) = 0\end{matrix} \qquad ( 4.5 )$$

4.2. Application of the Minimum Principles. Following (3.7) f for (A_{R}) is written as,

$$f ( x , v , u ) := \underbrace{[ \begin{matrix}- {\partial }_{x}^{2} E ( x ) v \\ 0\end{matrix} ]}_{{f}_{0}} + \underbrace{[ \begin{matrix}0 \\ u\end{matrix} ]}_{{f}_{1}} \qquad ( 4.6 )$$

Furthermore, if V: (λₓ, v) [symbol] [symbol] is a CLF, then a requirement is,

£_{f}V=− [symbol] ∂_{λ}_{ₓ} V (λₓ, v), ∂ₓ²E(x) v [symbol] + [symbol] ∂ᵥV(λₓ, v), u [symbol] <0 (4.7)

for some choice of u whenever (λₓ, v)≠(0, 0). In addition, (3.10) simplifies to,

[symbol]

∂_{λ}_{ₓ} V(λ_{xi , v}), ∂ₓ²E(x) v [symbol] >0 if ∂ᵥV(λₓ, v)=0 and (λₓ, v)≠(0,0) (4.8)

Furthermore, set is u=0 if ∂ᵥV=0. This last statement implies that the dynamical system (A_{R}) will continue to evolve as a result of v≠0.

Let [symbol] (x,λₓ, v, t) be a compact set that may vary with respect to the tuple (x,λₓ, v, t); then, (3.12) may be formulated as,

$$( {P}_{S} ) \{ \begin{matrix}{Minimize}_{u} & {ℒ}_{f} V := 〈 \partial V ( {λ}_{x} , v ) , f ( x , v , u ) 〉 \\ Subject to & u ∈ ( x , {λ}_{x} , v , t )\end{matrix} \qquad ( 4.9 )$$

To formulate Problem (P_{S}*) that is analogous to (3.14), selected is a function D: (u,x,λₓ, v) [symbol] [symbol] to be an appropriate objective function. Then, an application of (3.14) reduces to,

$$( {P}_{S}^{*} ) \{ \begin{matrix}{Minimize}_{u} & D ( u , x , {λ}_{x} , v , t ) \\ Subject to & {f}_{} V + ρ ( {λ}_{x} , v , x , t ) \leq 0\end{matrix} \qquad ( 4.1 )$$

The generation of accelerated algorithm primitives is now reduced to designing V and [symbol] in (P_{S}) or D,V and ρ in (P_{S}*).

4.3. Optimal Control for Some Accelerated Algorithm Primitives. Let W: (x,λₓ, v, t) [symbol] [symbol] ₊₊^{N}^{ₓ} be a symmetric positive definite matrix function that metricizes the space [symbol] . Following [Ref. 1], considered is

[symbol]

(x, λₓ, v, t):={u:u^{T}W (x, λₓ, v, t)u≤Δ(x, λₓ, v, t)} (4.11)

where Δ: (x, λₓ, v, t) [symbol] [symbol] ₊₊. Note that Δ is similar to, but is not, the familiar trust region in optimization. Under these conditions, a solution to (4.10) is given explicitly by,

$$u = \{ \begin{matrix}- σ [ @ t ] {W}^{- 1} [ @ t ] {\partial }_{v} V ( {λ}_{x} , v ) \\ 0\end{matrix} \begin{matrix} & if {\partial }_{v} V ( {λ}_{x} , v ) \neq 0 \\ & if {\partial }_{v} V ( {λ}_{x} , v ) = 0\end{matrix} \qquad ( 4.12 )$$

$$where ,$$

$$σ [ @ t ] := + \sqrt{\frac{Δ ( x , {λ}_{x} , v , t )}{[ {\partial }_{v} {V ( {λ}_{x} , v )}^{T} {W}^{- 1} [ @ t ] {\partial }_{v} V ( {λ}_{x} , v ) ]}} \qquad ( 4.13 )$$

### and W[@t]≡W(x, λₓ, v, t).

To illustrate an application of Minimum Principle (P*), selected is

$$D ( u , x , {λ}_{x} , v , t ) = \frac{1}{2} ( {u}^{T} W ( x , {λ}_{x} , v , t ) u ) \qquad ( 4.14 )$$

Solving the resulting problem, results in

$$u = \{ \begin{matrix}- {σ}^{*} [ @ t ] {W}^{- 1} [ @ t ] {\partial }_{v} V ( {λ}_{x} , v ) \\ 0\end{matrix} \begin{matrix}if {\partial }_{v} V ( {λ}_{x} , v ) \neq 0 \\ if {\partial }_{v} V ( {λ}_{x} , v ) = 0\end{matrix} \qquad ( 4.15 )$$

$$where ,$$

$${σ}^{*} [ @ t ] := \{ \begin{matrix}\frac{ξ ( {λ}_{x} , v , x , t )}{{[ {\partial }_{v} V ( {λ}_{x} , v ) ]}^{T} {W}^{- 1} [ @ t ] [ {\partial }_{v} V ( {λ}_{x} , v ) ]} \\ 0\end{matrix} \begin{matrix}if ξ ( {λ}_{x} , v , x ) \geq 0 \\ if ξ ( {λ}_{x} , v , x ) < 0\end{matrix} \qquad ( 4.16 )$$

$$and$$

$$ξ ( {λ}_{x} , v , x , t ) := ρ ( {λ}_{x} , v , x , t ) - 〈 {\partial }_{{λ}_{x}} V ( {λ}_{x} , v ) , {\partial }_{x}^{2} E ( x ) v 〉 \qquad ( 4.17 )$$

Comparing (4.12) and (4.15) it follows that for the choice of [symbol] and D given by (4.11) and (4.14) respectively, both minimum principles (P and P*) generate the same functional form for u but with different interpretations for the control “gains” given by σ and σ*.

### 4.4. Generation of ODEs For Some Accelerated Optimization Algorithms.

PROPOSITION 4.3. Let,

V (λₓ, v)=(a/2)λₓ^{T}λₓ+(b/2)v^{T}v+cλₓ^{T} v (4.18)

where, a>0, b>0 and c<0 are real numbers such that ab−c²>0. Then, if E is a strictly convex function, V(λₓ, v) is a CLF for the (A_{R})-(T_{R}) pair.

PROOF. The conditions a>0, b>0 and ab−c²>0 ensure that V is positive definite. The Lie derivative of V along f is given by,

£_{f}V= [symbol] aλ_{z}+cv, −∂ₓ²E(x)v [symbol] [symbol] cλₓ+bv, u [symbol] (4.19)

If cλₓ+bv≠0, then choosing u according to (4.15) ensures that £_{f}V<0 for any choice of ρ(λₓ, v, x)>0.

If cλₓ+bv=0, then £_{f1}V=0 for all choices of u. In this case, λₓ=−(b/c)v; hence, we have

$$\begin{matrix}{f 0}_{} V = 〈 a {λ}_{x} + cv , - {\partial }_{x}^{2} E ( x ) v 〉 \\ = ( \frac{ab - {c}^{2}}{c} ) {v}^{T} {\partial }_{x}^{2} E ( x ) v < 0 if ( {λ}_{x} , v ) \neq ( 0 , 0 )\end{matrix} \qquad ( 4.2 )$$

where, the inequality in (4.20) follows from c<0 and E strictly convex. Hence, V satisfies (3.10).

COROLLARY 4.4. Polyak's equation [Ref. 24] for the heavy ball method can be generated from the minimum principles (P_{S}) or (P_{S}*) using a Euclidean metric for W and the quadratic CLF given by (4.18).

PROOF. Let σ^{q} denote σ or σ* given by (4.13) and (4.16) respectively. Let,

γ^{a}[@t]:=−c σ^{q} [@t]≥0 (4.21a)

γ^{b}[@t]:=b σ^{q} [@t]≥0 (4.21b)

Using (4.18), the expression for u given by either (4.12) or (4.15) can be written universally as,

u=−W⁻¹[@t](γ^{a}[@t]∂ₓE(x)+γ^{b}[@t]v) (4.22)

where, used is the integral of motion λₓ=−∂ₓ E(x) in accordance with (2.14). Substituting (4.22) in (1.10) results in,

W[@t] \ddot{x}+γ^{a}[@t]∂ₓE(x)+γ^{b}[@t] v=0 (4.23)

Polyak's equation is given by [Ref. 24],

\ddot{x}+a₁(t) \dot{x}+a₂ (t) ∂ₓ E(x)=0 (4.24)

where a₁(t) 22 0 and a₂(t)>0 are time-varying scalar parameters. Equation (4.24) thus follows from (4.23) with W set to the identity matrix.

REMARK 4.5. Polyak “derived” (4.24) based on physical considerations of the motion of “a small heavy sphere” [Ref. 24]. A discrete analog of (4.24) generates his momentum method. In [Ref. 25], Polyak et al. argue that (4.24) also generates Nesterov's accelerated gradient method [Ref. 26] if a₁(t) is set to 3/t. This specific choice of a₁(t) is based on the results of Su et al. [Ref. 20].

From REMARK 4.5 it follows that (4.23) can generate both Polyak's momentum method and Nesterov's accelerated gradient method. Evidently, alternative accelerated optimization algorithms are possible by various selection of the parameters in (4.23).

A New Approach to Generating Algorithms. The results of Section 4 demonstrate that the minimum principles (P) and (P*) can successfully generate ODEs that govern the flow of accelerated algorithm primitives. It thus seems reasonable to suggest that algorithms can be produced by simply discretizing the resulting ODEs. This perspective is departed from for a variety of reasons, some of which are implied in REMARK 4.5. To clarify the need for a new approach to generating algorithms, consider a discretization of (4.23) with W set to the identity matrix. From elementary numerical methods, it is straightforward to produce the following algorithm:

$${x}_{k + 1} = {x}_{k} - {\underbrace{( {h}_{k}^{2} {γ}_{k}^{a} )}}_{{α}_{k}} {\partial }_{x} E ( {x}_{k} ) + {\underbrace{( 1 - {h}_{k} {γ}_{k}^{b} )}}_{{β}_{k}} ( {x}_{k} - {x}_{k - 1} ) \qquad ( 5.1 )$$

Equation (5.1) indicates the connections between a discretization step, hₖ, associated with (4.23), the step length, aₖ, in optimization, the momentum parameter, βₖ, associated with the heavy-ball method and the discretized controller gains γₖ^{a} and γₖ^{b}. In other words, if (4.23) is to reproduce a heavy-ball method, the controller gains, the method of discretization and the discretization step-sizes must all be chosen jointly in some interdependent manner. Furthermore, even if it were somehow possible to choose the controller gains judiciously, generating a candidate algorithm by simply discretizing the resulting ODE using well-established numerical methods may not be prudent because “the accuracy of the computed solution curve is not of prime importance” [Ref. 27]; rather, it is more important to arrive at the “asymptote of the solution . . . with the fewest function evaluations” [Ref. 27]. In view of these observations, Boggs [Ref. 27] proposed A stable methods of integration to solve the differential equations that were previously generated by Davidenko and Gavurin [Ref. 28]. Despite his breakthrough, such methods are not widely used because they remain computationally expensive, a fact that has been known for quite sometime (see [Ref. 29]). More recently, Grune and Karafyllis [Re. 30] developed a new idea based on framing a Runge-Kutta method as a hybrid dynamical system. In applying this approach to optimization, they concluded that “if the emphasis lies on a numerically cheap computation . . . then high order schemes may not necessarily be advantageous” [Ref. 30]

In pursuit of a new approach to generating algorithms, it was chosen to not produce the ODEs explicitly; and instead, reverted back to the new foundations (cf. Section 3) that generated the ODEs in the first place.

5.1. Development of a Three-Step Iterative Map. In acknowledging that the needs of optimization are substantially different from those of traditional control theory as well as numerical methods for solving ODEs, a new chart is coursed for producing algorithms using the following ideas:
1) Rather than design the ODEs that generate the algorithm primitives, the minimum principles are directly used within an algorithmic structure to find the instantaneous control ζ(k) at iteration k.
2) Because an ODE that governs the algorithm primitive is never generated, the next iterate is advanced to based on the geometric condition that every iterate remain on the zero-Hamiltonian singular manifold (cf. Theorem 2.4).

The first idea leans on the concept of proximal aiming introduced by Clarke et al. [Ref. 31] for an altogether different purpose of overcoming certain theoretical hurdles in nonsmooth control theory. The second idea relies on using the readily available singular integral of motion (cf. (2.14)) to generate λₓ (k+1) instead of discretizing and propagating its corresponding differential equation (cf. (3.4)). Similarly, s(k+1) is generated from (2.4) instead of discretizing (2.5). Consequently, only the simple linear equations in System (A) need be discretized. Collecting all these ideas together arrives at the following procedure: Let ζ(k):=(u(k), μ(k), ω(k)) and hₖ>0 be given. Then a three-step iterative map for accelerated optimization is given by,

$${A}_{1} ( k + 1 ) : \{ \begin{matrix}{λ}_{y} ( k + 1 ) = {λ}_{y} ( k ) + {h}_{k} ω ( k ) \\ {λ}_{s} ( k + 1 ) = {λ}_{s} ( k ) + {h}_{k} μ ( k ) \\ v ( k + 1 ) = v ( k ) + {h}_{k} u ( k )\end{matrix} \qquad ( 5.2 a )$$

$${A}_{2} ( k + 1 ) : \{ x ( k + 1 ) = x ( k ) + {h}_{k} v ( k + 1 ) \qquad ( 5.2 b )$$

$${A}_{3} ( k + 1 ) : \{ \begin{matrix}{λ}_{x} ( k + 1 ) = - {\partial }_{x} L ( {λ}_{y} ( k + 1 ) , {λ}_{s} ( k + 1 ) , x ( k + 1 ) ) \\ s ( k + 1 ) = e ( x ( k + 1 ) )\end{matrix} \qquad ( 5.2 c )$$

That is, A₁(k+1) is used to generate the (k+1)^{th} point for λ_{y}, λₛ and v by a forward Euler method. Next, the optimization variable x is updated in A₂(k+1) using a backward Euler formula. Despite being a backward Euler formula, A₂(k+1) is explicit because v(k+1) is available from A₁(k+1). Finally, λₓ and s are advanced to the (k+1)^{th} point in A₃(k+1) by not only sans discretization, but also that they are based on the most recent update of its arguments made available by A₁(k+1) and A₂(k+1).

REMARK 5.1. Equation (5.2) is essentially a semi-discretization of System (A) (cf. (3.5)).

REMARK 5.2. The backward Euler update for x in (5.2b) is essential not only for efficiency (i.e., in using the latest updates to generate new ones) but also to ensure consistency in terms of generating a Fritz John or KKT point. This is because if a forward Euler method were to be used to update x instead of (5.2b), then the sequence of iterates generated by (5.2) will not advance to an improved point if vₖ were to vanish for some k prior to achieving optimality. Note also that (5.2b) is implicitly contained in (5.1).

From (5.2) it follows that a feedback control law is never explicitly computed; hence, it is not necessary to produce an ODE that governs the flow of the algorithm primitive. Furthermore, because £_{f}V is linear in the control variable, Problems (P) and (P*) are “simpler” than the original problem (N). In particular, note that Problem (P*) is “small” scale; i.e., it has just one constraint equation, no matter the scale of the original problem (N).

5.2. Some New Step Length Procedures and Formulas. As noted earlier, it is inadvisable to choose hₖ in (5.2) based on the rules of numerical methods for ODEs. In view of this backdrop, proposed in [Ref. 1] is a minimum principle for a maximal step length. This principle is essentially an adaptation of the exact step length procedure used in standard optimization with the merit function replaced by the value of the CLF along the direction ζ(k). The key difference between the CLF and merit function approaches is that the former cannot be based on unconstrained optimization algorithms. In advancing the maximal step-length principle for the iterative map given by (5.2), posed is the following problem for generating an exact step length hₖ:

$$\begin{matrix}z := ( {λ}_{x} , {λ}_{y} , {λ}_{s} , v , s ) \\ ( {P}_{h} ) \{ \begin{matrix}{Minimize}_{z ( k + 1 ) , x ( k + 1 ) , {h}_{k}} & V ( z ( k + 1 ) ) \\ Subject to & \begin{matrix}{λ}_{x} ( k + 1 ) + {\partial }_{x} L ( {λ}_{y} ( k + 1 ) , \\ {λ}_{s} ( k + 1 ) , x ( k + 1 ) ) = 0\end{matrix} \\ & {λ}_{y} ( k + 1 ) - {λ}_{y} ( k ) - {h}_{k} ω ( k ) = 0 \\ & {λ}_{s} ( k + 1 ) - {λ}_{s} ( k ) - {h}_{k} μ ( k ) = 0 \\ & v ( k + 1 ) - v ( k ) - {h}_{k} u ( k ) = 0 \\ & s ( k + 1 ) - e ( x ( k + 1 ) ) = 0 \\ & x ( k + 1 ) - x ( k ) - {h}_{k} v ( k + 1 ) = 0 \\ & {h}_{k} \geq 0\end{matrix}\end{matrix} \qquad ( 5.3 )$$

Assuming hₖ>0, the dual feasibility conditions for Problem (Pₕ) are given by,

$${\partial }_{z} V ( z ( k + 1 ) ) + [ \begin{matrix}{ψ}_{{λ}_{s}} \\ {ψ}_{{λ}_{y}} + {\partial }_{x} E ( x ( k + 1 ) ) \cdot {ψ}_{{λ}_{x}} \\ {ψ}_{{λ}_{s}} + [ {\partial }_{x} e ( x ( k + 1 ) ) ] {ψ}_{{λ}_{s}} \\ {ψ}_{v} - {h}_{k} {ψ}_{x} \\ {ψ}_{s}\end{matrix} ] = 0 \qquad ( 5.4 a )$$

$$[ {\partial }_{x}^{2} L ( {λ}_{y} ( k + 1 ) , {λ}_{s} ( k + 1 ) , x ( k + 1 ) ) ] {ψ}_{{λ}_{x}} - {\partial }_{x} e ( x ( k + 1 ) ) \cdot {ψ}_{s} + {ψ}_{x} = 0 \qquad ( 5.4 b )$$

$${ψ}_{{λ}_{y}} ω ( k ) + {ψ}_{{λ}_{s}} \cdot μ ( k ) + {ψ}_{v} \cdot u ( k ) - {ψ}_{x} \cdot v ( k + 1 ) = 0 \qquad ( 5.4 c )$$

where, ψ_{λ}_{ₓ}, ψ_{λ}_{_{y}}, ψ_{λ}_{ₛ}, ψᵥ, ψₛ and ψₓ are Lagrange multipliers associated with the constraint equations given in (5.3).

REMARK 5.3. Because Problem (Ph) incorporates (5.2), it also generates the iterates to solve Problem (N); i.e., if Problem (Pₕ) can be solved “exactly,” then its solution, together with that of any one of the minimum principles represents the complete algorithm.

It is apparent by a cursory inspection of the primal and dual feasibility conditions of Problem (Pₕ) that producing an explicit equation for hₖ in terms of the known information at k is not readily possible; in fact, this challenge is not altogether different than the problem of generating an exact step length formula using standard merit functions. In view of this, it is apparent that hₖ may be generated more efficiently by using the traditional approach of inexact line search methods (i.e., Armijo-Goldstein-Wolfe methods) but adapted to the values of the CLF along the direction ζ(k). Nonetheless, as is well-known, the efficiency of such methods are more strongly dependent on the initial value of hₖ rather than the specifics of backtracking. Consequently, motivated by the need to produce a “good” initial value for hₖ, advanced are three formulas.

The first approach is based on approximating the constraints in Problem (Pₕ) and solving the resulting problem. The constraint approximations are based on the first order terms in hₖ; this generates the following approximations:

∂ₓL(λ_{y} (k+1), λₛ (k+1), x (k+1))≈∂ₓL (λ_{y} (k), λₛ (k), x (k))+hₖ ∂ₓ² L(λ_{y} (k), λₛ (k), x(k)) v(k+1)+hₖ ∂ₓ L (ω(k), μ(k), x (k)) (5.5a)

e(x(k+1))≈e(x(k))+hₕ ∂_{z}e(x(k))v(k+1) (5.5b)

∂ₓ² L(λ_{y} (k+1), λₛ (k+1), x (k+1))≈∂ₓ²L(λ_{y} (k), λₛ (k)m x(k)) (5.5c)

∂ₓ e(x(k+1))≈∂ₓe(x(k)) (5.5d)

∂ₓ E(x(k+1))≈∂ₓ E(x(k)) (5.5e)

PROPOSITION 5.4. Suppose a CLF is given by the quadratic function V(z)=(z^{T}Qz)/2 where, Q is a positive definite matrix. Assume (5.5) holds. Let zₐ(k+1) denote the approximate value of z based on the approximations given by (5.5). Then, a solution to hₖ=hₖ^{BL} satisfies the system of bilinear equations given by,

$${M}_{1} ( k ) [ \begin{matrix}χ \\ {h}_{k}^{BL}\end{matrix} ] + {h}_{k}^{BL} {M}_{2} ( k ) χ = {b}_{k} \qquad ( 5.6 )$$

where, M₁(k), M₂(k) and bₖ are matrices (of appropriate dimensions) that depend on the known values of the iterates of (5.2) at the point k, and x is a variable that comprises zₐ(k+1), ψ_{λ}_{ₓ}, ψ_{λ}_{_{y}}, ψ_{λ}_{ₛ}, ψᵥ, ψₛ and ψₓ.

PROOF. The result follows from two simple steps: Replace v(k+1) in (5.4c) by v(k)+hₖu(k). Substitute (5.5) in (5.4) and (5.2).

REMARK 5.5. The approximations given by (5.5) are only used to generate hₖ^{BL} via (5.6). In other words, zₐ(k+1) generated from (5.6) is discarded once hₖ^{BL} is computed.

A second formula for an initial value of hₖ is given by the following proposition: PROPOSITION 5.6 ([1]). Let V(z)=(z^{T}Qz)/2 where, Q is a positive definite matrix. Suppose all of the constraint equations in (5.3) are replaced by a forward Euler discretization. Then, the resulting maximal step length is given explicitly by,

$${h}_{k}^{FE} = - \frac{{z}_{k}^{T} {Qf}_{k}}{{f}_{k}^{T} {Qf}_{k}} = \frac{- {f}_{} V ( {z}_{k} )}{2 V ( {f}_{k} )} \qquad ( 5.7 )$$

where fₖ=f(zₖ, ζₖ) and f is given by (3.7). Because the minimum principles (P) and (P*) generate £_{f}V(zₖ)<0, it follows that (5.7) guarantees hₖ^{FE}>0. The main problem in using hr in (5.2) is its inconsistency as discussed in REMARK 5.2; however, it holds the potential of providing a lower bound for an acceptable step size in a Goldstein-type condition.

Finally, a third formula for an initial value of hk is obtained by utilizing the fact that £_{f}V(zₖ) is the continuous-time derivative of V at the point zₖ. As a result, the tangent line emanating from the point zₖ may be parameterized as,

V^{tan}(s)=s£_{f} V (zₖ)+V (zₖ) (5.8)

Setting V^{tan}(s)=0 in (5.8) to solve for s as a proposed value for an initial step size generates the very simple formula,

$${h}_{k}^{tan} = \frac{V ( {z}_{k} )}{- {f}_{} V ( {z}_{k} )} \qquad ( 5.9 )$$

5.3. Description of the Main Algorithm. The main algorithm comprises two key steps:

Step A) At step k, solve Problem (P) or (P*) to generate ζ(k). For a quadratic CLF, this only requires a solution to a linear system; see (3.12) and (3.14).

Step B) Using the computed value of ζ(k) from the prior step, advance to step (k+1) using (5.2) such that Vₖ₊₁ is sufficiently less than Vₖ, where Vₖ₊₁ is the value of the CLF at the accepted point (k+1).

The major steps of the proposed/disclosed algorithm, and exemplary embodiments described herein, are encapsulated in Algorithm 5.1.

```
Algorithm 5.1 Main
Choose a CLF V and the parameters associated with Problem (P) or
(P*)(cf. (3.12) and (3.14))
Initialize the algorithm according to: λₓ⁰ = −∂ₓL(1, λₛ⁰, x⁰), s⁰ = e(x⁰).
Set k = 0.
Compute Vₖ = V(z(k))
while stopping conditions are not met do
    Generate ζ(k) by solving Problem (P*)( or (P))
    Compute hₖ⁰ using any one of (5.6), (5.7) or (5.9)
    Advance to (z(k + 1), x(k + 1)) using (5.2) and hₖ⁰
    Compute Vₖ₊₁ = V(z(k + 1))
    while Vₖ₊₁ has not decreased sufficiently do
      Backtrack (z(k + 1), x(k + 1)) along ζ(k); recompute Vₖ₊₁
  end while
  Update k ← k + 1
end while
```

5.4. A Numerical Illustration. Presented here is a simple numerical example to demonstrate the acceleration generated by an application of Algorithm 5.1. Shown in FIG. 3 are six iterates of Algorithm 5.1 applied to minimize the function (x₁, x₂) [symbol] (x₁²+10x₂²)/2. The iterates were obtained by setting W to be identity matrix (cf. Section 4); hence the resulting algorithm is a new gradient method. To demonstrate the fact that this new gradient method does indeed achieve acceleration, the iterates of a standard gradient method for the same number of iterations (i.e., six) are shown in FIG. 4. To provide an additional perspective in terms of an acceleration factor generated by an application of Algorithm 5.1, iterates of the standard gradient method for double and triple the number of iterations are shown in FIG. 5 and FIG. 6 respectively.

6. Conclusions. The transversality mapping principle and its consequences facilitate new ideas for designing and analyzing optimization algorithms. A general framework for accelerated (and unaccelerated) optimization methods is possible under the rubric singular optimal control theory. On hindsight, the central role of singular optimal control theory is not surprising because a nonsingular control would have implied a universal optimal algorithm. By the same token, the infinite-order of the singular arc is also not surprising because a finite order would also imply a universal optimal algorithm. The interesting aspect of many well-known algorithms accelerated or otherwise—is that their primitives are all describable in terms of flows over a zero-Hamiltonian singular manifold. This insight is used to launch a three-step iterative map that generates iterates which remain on the singular manifold. It turns out that the key steps to computational efficiency is not necessarily based on discretizing the resulting ordinary differential equations, rather, it is based on combining the more traditional aspects of optimization with the generation of Euler polygonal arcs by proximal aiming. There is no doubt that a vast number of open questions remain; however, it is evident that new viable optimization algorithms can indeed be generated using the results emanating from the transversality mapping principle.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A method for processing digital representations of a group of objects and identifying within the group of objects a target object, the method including the execution of an accelerated optimization method to identify the target object within the digital representations of the group of objects, the accelerated optimization method comprising:
a) a user choosing a CLF V convergence condition;
b) initializing the accelerated optimization method according to:
λₓ⁰=−∂ₓL(1, λₛ⁰, x⁰), s⁰=e (x⁰) and setting k=0;
c) computing Vₖ=V(z(k));
d) while stopping conditions are not met do;
d1) generate ζ(k);
d2) compute hₖ⁰;
d3) advance to (z(k+1), x(k+1)) using hₖ⁰;
d4) compute Vₖ₊₁=V (z (k+1));
d5) while Vₖ₊₁ has not decreased sufficiently do;
d4a) backtrack (z(k+1), x(k+1)) along ζ(k); recompute Vₖ₊₁;
d6) end while; and
d7) update k←k+1; and
e) end while.

2. The method for processing digital representations of a group of objects according to claim 1, wherein step a) of the accelerated optimization method includes:
a user choosing a CLF V convergence condition and the parameters associated with a Problem (P) or (P*); and
wherein step d1) includes generating ζ(k) by solving Problem (P*)(or (P)).

3. The method for processing digital representations of a group of objects according to claim 1, wherein step d2) includes:
computing hₖ⁰ using,
$${M}_{1} ( k ) [ \begin{matrix}χ \\ {h}_{k}^{BL}\end{matrix} ] + {h}_{k}^{BL} {M}_{2} ( k ) χ = {b}_{k} ,$$
where, M₁(k), M₂(k) and bₖ are matrices (of appropriate dimensions) that depend on the known values of iterates of at point k, and x is a variable that comprises zₐ(k+1), ψ_{λ}_{ₓ}, Ψ_{λ}_{_{y}}, ψ_{λ}_{ₛ}, ψᵥ, ψₛ and ψₓ, the known values of iterates given by:
$${A}_{1} ( k + 1 ) : \{ \begin{matrix}{λ}_{y} ( k + 1 ) = {λ}_{y} ( k ) + {h}_{k} ω ( k ) \\ {λ}_{s} ( k + 1 ) = {λ}_{s} ( k ) + {h}_{k} μ ( k ) \\ v ( k + 1 ) = v ( k ) + {h}_{k} u ( k )\end{matrix}$$
$${A}_{2} ( k + 1 ) : \{ x ( k + 1 ) = x ( k ) + {h}_{k} v ( k + 1 )$$
$${A}_{3} ( k + 1 ) : \{ \begin{matrix}{λ}_{x} ( k + 1 ) = - {\partial }_{x} L ( {λ}_{y} ( k + 1 ) , {λ}_{s} ( k + 1 ) , x ( k + 1 ) ) \\ s ( k + 1 ) = e ( x ( k + 1 ) )\end{matrix} .$$

4. The method for processing digital representations of a group of objects according to claim 1, wherein step d2) includes:
computing hₖ⁰ using,
$${h}_{k}^{FE} = - \frac{{z}_{k}^{T} {Qf}_{k}}{{f}_{k}^{T} {Qf}_{k}} = \frac{- {f}_{} V ( {z}_{k} )}{2 V ( {f}_{k )}} ,$$
where fₖ=f(zₖ, ζₖ) and f is given by,
$$\dot{z} = f ( {λ}_{y} , {λ}_{s} , v , x , ζ ) := {\underbrace{[ \begin{matrix}- [ {\partial }_{x}^{2} L ( {λ}_{y ,} {λ}_{s} , x ) ] v \\ 0 \\ 0 \\ 0 \\ ( {\partial }_{x} e ( x ) ] v\end{matrix} ]}}_{{f}_{0}} + {\underbrace{[ \begin{matrix}- [ {\partial }_{x} L ( {ω}_{,} μ , x ) \\ ω \\ μ \\ u \\ 0\end{matrix} ]}}_{{f}_{1}} ,$$
where,
z:=(λₓ, λ_{y}, λₛ, v, s)
ζ:=(u, μw)
f₀≡f₀(λ_{y}, λₛ, v, x)
f₁≡f₁ (x, ζ)

5. The method for processing digital representations of a group of objects according to claim 1, wherein step d2) includes:
computing hₖ⁰ using,
$${h}_{k}^{tan} = \frac{V ( {z}_{k} )}{- {f}_{} V ( {z}_{k} )} .$$

6. The method for processing digital representations of a group of objects according to claim 1, wherein step d3) includes:
advancing to (z(k+1), x(k+1)) using hₖ⁰ and
$${A}_{1} ( k + 1 ) : \{ \begin{matrix}{λ}_{y} ( k + 1 ) = {λ}_{y} ( k ) + {h}_{k} ω ( k ) \\ {λ}_{y} ( k + 1 ) = {λ}_{y} ( k ) + {h}_{k} μ ( k ) \\ υ ( k + 1 ) = υ ( k ) + {h}_{k} u ( k )\end{matrix}$$
$${A}_{2} ( k + 1 ) : \{ x ( k + 1 ) = x ( k ) + {h}_{k} υ ( k + 1 )$$
$${A}_{3} ( k + 1 ) : \{ \begin{matrix}{λ}_{x} ( k + 1 ) = - {\partial }_{x} L ( {λ}_{y} ( k + 1 ) , {λ}_{s} ( k + 1 ) , x ( k + 1 ) ) \\ s ( k + 1 ) = e ( x ( k + 1 ) )\end{matrix} .$$

7. The method for processing digital representations of a group of objects according to claim 1, wherein the digital representations of a group of objects includes a plurality of object pixel images and the target object is a pixel image of the target image.

8. The method for processing digital representations of a group of objects according to claim 1, wherein the digital representations of a group of objects includes a plurality of objects associated with characteristics of a device or process and the target object is a target object associated with a target characteristic of the device or process.

9. A method for modeling a device or process to generate a model based on a group of digital representations of the device or process characteristics, the method including the execution of an accelerated optimization method to classify the digital representations of the device or process associated with each digital representation, the accelerated optimization method comprising:
a) a user choosing a CLF V convergence condition;
b) initializing the accelerated optimization method according to:
λₓ⁰=<∂ₓL(1, λₛ⁰, x⁰), s⁰=e(x⁰) and setting k=0;
c) computing Vₖ=V(z(k));
d) while stopping conditions are not met do;
d1) generate ζ(k);
d2) compute hₖ⁰;
d3) advance to (z(k+1), x(k+1)) using hₖ⁰;
d4) compute Vₖ₊₁=V(z(k+1));
d5) while Vₖ₊₁ has not decreased sufficiently do;
d4a) backtrack (z(k+1), x(k+1)) along ζ(k); recompute Vₖ₊₁;
d6) end while; and
d7) update k←k+1; and
e) end while.

10. The method for modeling a device or process according to claim 9, wherein step a) of the accelerated optimization method includes:
a user choosing a CLF V convergence condition and the parameters associated with a Problem (P) or (P*); and
wherein step d1) includes generating ζ(k) by solving Problem (P*)(or (P)).

11. The method for modeling a device or process according to claim 9, wherein step d2) includes:
computing hₖ⁰ using,
$${M}_{1} ( k ) [ \begin{matrix}χ \\ {h}_{k}^{BL}\end{matrix} ] + {h}_{k}^{BL} {M}_{2} ( k ) χ = {b}_{k} ,$$
where, M₁(k), M₂(k) and bₖ are matrices (of appropriate dimensions) that depend on the known values of iterates of at point k, and x is a variable that comprises zₐ(k+1), ψ_{λ}_{ₓ}, ψ_{λ}_{_{y}}, ψ_{λ}_{ₛ}, ψᵥ, ψₛ and ψₓ, the known values of iterates given by:
$${A}_{1} ( k + 1 ) : \{ \begin{matrix}{λ}_{y} ( k + 1 ) = {λ}_{y} ( k ) + {h}_{k} ω ( k ) \\ {λ}_{y} ( k + 1 ) = {λ}_{y} ( k ) + {h}_{k} μ ( k ) \\ υ ( k + 1 ) = v ( k ) + {h}_{k} u ( k )\end{matrix}$$
$${A}_{2} ( k + 1 ) : \{ x ( k + 1 ) = x ( k ) + {h}_{k} v ( k + 1 )$$
$${A}_{3} ( k + 1 ) : \{ \begin{matrix}{λ}_{x} ( k + 1 ) = - {\partial }_{x} L ( {λ}_{y} ( k + 1 ) , {λ}_{s} ( k + 1 ) , x ( k + 1 ) ) \\ s ( k + 1 ) = e ( x ( k + 1 ) )\end{matrix} .$$

12. The method for modeling a device or process according to claim 9, wherein step d2) includes:
computing hₖ⁰ using,
$${h}_{k}^{FE} = - \frac{{z}_{k}^{T} {Qf}_{k}}{{f}_{k}^{T} Q {f}_{k}} = \frac{- {f}_{} V ( {z}_{k} )}{2 V ( {f}_{k} )} ,$$
where fₖ=f(zₖ, ζₖ) and f is given by,
$$\dot{z} = f ( {λ}_{y} , {λ}_{s} , v , x , ζ ) := {\underbrace{[ \begin{matrix}- [ {\partial }_{x}^{2} L ( {λ}_{y ,} {λ}_{s} , x ) ] v \\ 0 \\ 0 \\ 0 \\ ( {\partial }_{x} e ( x ) ] v\end{matrix} ]}}_{{f}_{0}} + {\underbrace{[ \begin{matrix}- [ {\partial }_{x} L ( {ω}_{,} μ , x ) \\ ω \\ μ \\ u \\ 0\end{matrix} ]}}_{{f}_{1}} ,$$
where,
z:=(λₓ, λ_{y}, λₛ, v, s)
ζ:=(u, μ, ω)
f₀≡f₀ (λ_{y}, λₛ, v, x)
f₁≡f₁ (x, ζ)

13. The method for modeling a device or process according to claim 9, wherein step d2) includes:
computing hₖ⁰ using,
$${h}_{k}^{tan} = \frac{V ( {z}_{k} )}{- {f}_{} V ( {z}_{k} )} .$$

14. The method for modeling a device or process according to claim 9,
$${A}_{1} ( k + 1 ) : \{ \begin{matrix}{λ}_{y} ( k + 1 ) = {λ}_{y} ( k ) + {h}_{k} ω ( k ) \\ {λ}_{y} ( k + 1 ) = {λ}_{y} ( k ) + {h}_{k} μ ( k ) \\ v ( k + 1 ) = v ( k ) + {h}_{k} u ( k )\end{matrix}$$
$${A}_{2} ( k + 1 ) : \{ x ( k + 1 ) = x ( k ) + {h}_{k} v ( k + 1 )$$
$${A}_{3} ( k + 1 ) : \{ \begin{matrix}{λ}_{x} ( k + 1 ) = - {\partial }_{x} L ( {λ}_{y} ( k + 1 ) , {λ}_{s} ( k + 1 ) , x ( k + 1 ) ) \\ s ( k + 1 ) = e ( x ( k + 1 ) )\end{matrix} .$$

15. An apparatus for processing digital representations of a group of objects and identifying within the group of objects a target object, the apparatus including the execution of an accelerated optimization method to identify the target object within the digital representations of the group of objects , the accelerated optimization method comprising:
a) a user choosing a CLF V convergence condition;
b) initializing the accelerated optimization method according to:
λₓ⁰=−∂ₓL(1, λₛ⁰, x⁰), s⁰=e(x⁰) and setting k=0;
c) computing Vₖ=V(z(k));
d) while stopping conditions are not met do;
d1) generate ζ(k);
d2) compute hₖ⁰;
d3) advance to (z(k+1), x(k+1)) using hₖ⁰;
d4) compute Vₖ₊₁=V(z(k+1));
d5) while Vₖ₊₁ has not decreased sufficiently do;
d4a) backtrack (z(k+1), x(k+1)) along λ(k); recompute Vₖ₊₁;
d6) end while; and
d7) update k←k+1; and
e) end while.

16. The apparatus for processing digital representations of a group of objects according to claim 15, wherein step a) of the accelerated optimization method includes:
a user choosing a CLF V convergence condition and the parameters associated with a Problem (P) or (P*); and
wherein step d1) includes generating ζ(k) by solving Problem (P*)(or (P)).

17. The apparatus for processing digital representations of a group of objects according to claim 15, wherein step d2) includes:
computing hₖ⁰ using,
$${M}_{1} ( k ) [ \begin{matrix}χ \\ {h}_{k}^{BL}\end{matrix} ] + {h}_{k}^{BL} {M}_{2} ( k ) χ = {b}_{k} ,$$
where, M₁(k), M₂(k) and bₖ are matrices (of appropriate dimensions) that depend on the known values of iterates of at point k, and x is a variable that comprises zₐ(k+1), ψ_{λ}_{ₓ}, ψ_{λ}_{_{y}}, ψ_{λ}_{ₛ}, ψᵥ, ψₛ and ψₓ, the known values of iterates given by:
$${A}_{1} ( k + 1 ) : \{ \begin{matrix}{λ}_{y} ( k + 1 ) = {λ}_{y} ( k ) + {h}_{k} ω ( k ) \\ {λ}_{y} ( k + 1 ) = {λ}_{y} ( k ) + {h}_{k} μ ( k ) \\ v ( k + 1 ) = v ( k ) + {h}_{k} u ( k )\end{matrix}$$
$${A}_{2} ( k + 1 ) : \{ x ( k + 1 ) = x ( k ) + {h}_{k} v ( k + 1 )$$
$${A}_{3} ( k + 1 ) : \{ \begin{matrix}{λ}_{x} ( k + 1 ) = - {\partial }_{x} L ( {λ}_{y} ( k + 1 ) , {λ}_{s} ( k + 1 ) , x ( k + 1 ) ) \\ s ( k + 1 ) = e ( x ( k + 1 ) )\end{matrix} .$$

18. The apparatus for processing digital representations of a group of objects according to claim 15, wherein step d2) includes:
computing hₖ⁰ using,
$${h}_{k}^{FE} = - \frac{{z}_{k}^{T} {Qf}_{k}}{{f}_{k}^{T} Q {f}_{k}} = \frac{- {f}_{} V ( {z}_{k} )}{2 V ( {f}_{k} )} ,$$
where fₖ=f(zₖ, ζₖ) and f is given by,
$$\dot{z} = f ( {λ}_{y} , {λ}_{s} , v , x , ζ ) := {\underbrace{[ \begin{matrix}- [ {\partial }_{x}^{2} L ( {λ}_{y ,} {λ}_{s} , x ) ] v \\ 0 \\ 0 \\ 0 \\ ( {\partial }_{x} e ( x ) ] v\end{matrix} ]}}_{{f}_{0}} + {\underbrace{[ \begin{matrix}- [ {\partial }_{x} L ( {ω}_{,} μ , x ) \\ ω \\ μ \\ u \\ 0\end{matrix} ]}}_{{f}_{1}} ,$$
where,
z:=(λₓ, λ_{y}, λₛ, v, s) ζ:=(u, μ, w)
f₀≡f₀ (λ_{y}, λₛ, v, x) f₁≡f₁ (x, ζ)

19. The apparatus for processing digital representations of a group of objects according to claim 15, wherein step d2) includes:
computing hₖ⁰ using,
$${h}_{k}^{tan} = \frac{V ( {z}_{k} )}{- {f}_{} V ( {z}_{k} )} .$$

20. A method for accelerating optimization, the method comprising: selecting a control Lyapunov function (CLF) and associated parameters for an optimization problem;
generate an algorithm to solve the optimization problem according to λₓ⁰=∂ₓL(1, λₛ⁰, x⁰), s⁰=e(x⁰), where k is set to 0;
until stopping conditions are reached:
generating ζ(k) by solving the optimization problem;
computing hₖ⁰ using at least one of a group consisting of
$${M}_{1} ( k ) [ \begin{matrix}χ \\ {h}_{k}^{BL}\end{matrix} ] + {h}_{k}^{BL} {M}_{2} ( k ) χ = {b}_{k} ,$$
$${h}_{k}^{FE} = - \frac{{z}_{k}^{T} {Qf}_{k}}{{f}_{k}^{T} Q {f}_{k}} = \frac{- {f}_{} V ( {z}_{k} )}{2 V ( {f}_{k} )} ,$$
$$and$$
$${h}_{k}^{tan} = \frac{V ( {z}_{k} )}{- {f}_{} V ( {z}_{k} )} .$$
advancing to (z(k+1), x(k+1) using a three-step iterative map and hₖ⁰;
computing Vₖ₊₁=V(z(k+1)).
until Vₖ₊₁ has decreased to a target threshold, backtracking (z(k+1), x(k+1)) along ζ(k) and recomputing Vₖ₊₁; and
incrementing k to the next step.
